(19) United States
(12) Patent Application Publication
(10) Pub. No.: US 2026/0005452 A1
(43) Pub. Date: Jan. 1, 2026

(54) TERMINAL CONNECTION UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuki FUJIMURA, Osaka (JP); Hitoshi TAKEDA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/862,639

(22) PCT Filed: Mar. 28, 2023
(86) PCT No.: PCT/JP2023/012521

§ 371 Date: Aug. 18, 2025

(30) Foreign Application Priority Data
May 19, 2022 (JP) 2022-082190

(51) Int. Cl. H01R 4/34

(52) U.S. Cl. CPC H01R 4/34; H01R 2201/26

(57) ABSTRACT

A terminal connection unit is disclosed that has a small number of components and a simple structure and is capable of absorbing tolerances. A terminal connection unit includes an electrically conductive member having a connection portion to which a partner terminal is connected, and a support portion that supports the electrically conductive member in a fixed manner. The support portion has a coupling member that couples the partner terminal and the connection portion in the electrically conductive member to each other. When an external force accompanying the displacement of the partner terminal is exerted on the coupling member, the coupling member can be displaced with respect to the support portion main body in the support portion.

### TECHNICAL FIELD

The present disclosure relates to a terminal connection unit.

### BACKGROUND ART

Conventionally, various devices, electrical connection boxes, and the like mounted in a vehicle have been provided with terminal connection units having connection portions to which partner terminals are connected. For example, as described in Patent Document 1, such a terminal connection unit has a support portion that supports, in a fixed manner, an electrically conductive member routed in various devices or an electrical connection box, and a connection portion provided at an end of the electrically conductive member is attached to an attachment portion provided so as to be displaceable in a first direction with respect to the support portion. Furthermore, the electrically conductive member has an expandable portion that is expandable and contractable in the first direction between the connection portion and a fixing portion fixed to the support portion. As a result, the position of the connection portion can be varied in the first direction by expanding and contracting the expandable portion in the first direction and displacing the attachment portion, and thus it is possible to advantageously absorb a positional tolerance between the external terminal and the connection portion.

### CITATION LIST

### Patent Documents

Patent Document 1: WO 2021/157420

### SUMMARY OF INVENTION

### Technical Problem

However, in the structure of Patent Document 1, the expandable portion of the electrically conductive member needs to be formed using a braided wire or a laminated busbar. Therefore, there has been demand for an improved structure that has a small number of components and a simple structure and is capable of absorbing a tolerance.

In view of this, a terminal connection unit is disclosed that has a small number of components and a simple structure and is capable of absorbing a tolerance.

### Solution to the Problem

A terminal connection unit according to the present disclosure includes: an electrically conductive member having a connection portion to which a partner terminal is to be connected; and a support portion configured to support the electrically conductive member in a fixed manner, in which the support portion includes a coupling member configured to couple the partner terminal and the connection portion of the electrically conductive member to each other, and the coupling member is displaceable with respect to a support portion main body of the support portion due to an external force accompanying displacement of the partner terminal being exerted on the coupling member.

### Advantageous Effects of the Invention

According to the present disclosure, it is possible to provide a terminal connection unit that has a small number of parts and a simple structure and is capable of absorbing a tolerance.

### BRIEF DESCRIPTION OF DRAWINGS

FIG. 1 is a perspective view showing a state in which a connection portion and a partner terminal are connected to each other at one connection position in a terminal connection unit according to a first embodiment.

FIG. 2 is a plan view of the terminal connection unit shown in FIG. 1.

FIG. 3 is a cross-sectional view taken along line III-III in FIG. 2.

FIG. 4 is an exploded perspective view of the terminal connection unit shown in FIG. 1.

FIG. 5 is a plan view showing a state in which the connection portion and the partner terminal are connected to each other at another connection position in the terminal connection unit shown in FIG. 1.

FIG. 6 is a cross-sectional view taken along line VI-VI in FIG. 5.

FIG. 7 is a plan view showing a state in which the connection portion and the partner terminal are connected to each other at yet another connection position in the terminal connection unit shown in FIG. 1.

FIG. 8 is a cross-sectional view taken along line VIII-VIII in FIG. 7.

FIG. 9 is a perspective view showing a state in which a connection portion and a partner terminal are connected to each other in a terminal connection unit according to a second embodiment.

FIG. 10 is a plan view of the terminal connection unit shown in FIG. 9.

FIG. 11 is a cross-sectional view taken along line XI-XI in FIG. 10.

FIG. 12 is an exploded perspective view of the terminal connection unit shown in FIG. 9.

FIG. 13 is a perspective view showing a holder included in the terminal connection unit shown in FIG. 9, in a view from the bottom.

FIG. 14 is a perspective view showing a state in which the partner terminal has started to be accommodated in a partner terminal accommodation portion in the terminal connection unit shown in FIG. 9.

FIG. 15 is a cross-sectional view taken along line XV-XV in FIG. 14.

FIG. 16 is a perspective view showing a state in which a partner terminal is further accommodated in a partner terminal accommodation portion from the state shown in FIG. 14 in the terminal connection unit shown in FIG. 9.

FIG. 17 is a cross-sectional view taken along line XVII-XVII in FIG. 16.

FIG. 18 is a perspective view showing a state in which a connection portion and a partner terminal are connected to each other in a terminal connection unit according to a third embodiment.

FIG. 19 is an exploded perspective view of the terminal connection unit shown in FIG. 18.

FIG. 20 is an illustrative diagram for illustrating a mechanism for absorbing a tolerance when a partner terminal is shorter than a reference dimension in the terminal connection unit shown in FIG. 18, and is a plan view of the terminal connection unit.

FIG. 21 is an illustrative diagram for illustrating a mechanism for absorbing a tolerance when the partner terminal is shorter than the reference dimension in the terminal connection unit shown in FIG. 18, and shows a state continued from FIG. 20.

FIG. 22 is an illustrative diagram for illustrating a mechanism for absorbing a tolerance when the partner terminal is shorter than the reference dimension in the terminal connection unit shown in FIG. 18, and shows a state continued from FIG. 21.

FIG. 23 is an illustrative diagram for illustrating a mechanism for absorbing a tolerance when the partner terminal is longer than the reference dimension in the terminal connection unit shown in FIG. 18, and is a plan view of the terminal connection unit.

FIG. 24 is an illustrative diagram for illustrating a mechanism for absorbing a tolerance when the partner terminal is longer than the reference dimension in the terminal connection unit shown in FIG. 18, and shows a state continued from FIG. 23.

FIG. 25 is an illustrative diagram for illustrating a mechanism for absorbing a tolerance when the partner terminal is longer than the reference dimension in the terminal connection unit shown in FIG. 18, and shows a state continued from FIG. 24.

### OVERVIEW OF EMBODIMENTS OF THE DISCLOSURE

### Description of Embodiments of the Present Disclosure

First, embodiments of the present disclosure will be listed and described.

A terminal connection unit of the present disclosure includes:
an electrically conductive member having a connection portion to which a partner terminal is to be connected; and a support portion configured to support the electrically conductive member in a fixed manner, in which the support portion includes a coupling member configured to couple the partner terminal and the connection portion of the electrically conductive member to each other, and the coupling member is displaceable with respect to a support portion main body of the support portion due to an external force accompanying displacement of the partner terminal being exerted on the coupling member.

According to the terminal connection unit of the present disclosure, the external force accompanying the displacement of the partner terminal can be utilized to displace the coupling member, for example, to a position where the partner terminal and the connection portion can be coupled to each other. Therefore, there is no need to positionally align the partner terminal, the connection portion, and the coupling member, and the coupling member can easily couple the partner terminal and the connection portion to each other. This makes it possible to provide a terminal connection unit that has a small number of components and a simple structure and can absorb a tolerance, without providing an expandable portion made of a braided wire or laminated busbar in the electrically conductive member as in a conventional structure.

Note that the terminal connection unit may be integrally provided in a case or the like of a vehicle-mounted component such as a junction box, or may be provided separately from the vehicle-mounted component and mounted on the outer surface of or in the vicinity of the vehicle-mounted component.

It is preferable that the connection portion of the electrically conductive member has an elongated bolt insertion hole extending in a first direction, the coupling member is constituted by a holder that is disposed below the connection portion and is attached to the support portion so as to be displaceable in the first direction, the holder holds a nut or a bolt, the holder includes a connection portion accommodation portion that is disposed above the nut or the bolt and is configured to accommodate the connection portion so as to be fastenable to the nut or the bolt, a partner terminal accommodation portion configured to accommodate the partner terminal, and a contact portion configured to come into contact with the partner terminal, and due to the partner terminal coming into contact with the contact portion, the partner terminal is guided into the partner terminal accommodation portion so as to be fastenable to the nut or the bolt, and the holder is displaced in the first direction.

The bolt insertion hole that is elongated in the first direction is provided in the connection portion of the electrically conductive member, and the holder constituting the coupling member is attached to the support portion that supports the electrically conductive member in a fixed manner, such that the holder is displaceable in the first direction. The holder holds the nut or the bolt and has the connection portion accommodating portion in which the connection portion is disposed above the nut or the bolt such that the connection portion is fastenable to the nut or the bolt. Furthermore, by bringing the partner terminal into contact with the contact portion provided on the holder, the partner terminal can be guided into the partner terminal accommodation portion of the holder such that the partner terminal is fastenable to the nut or the bolt held by the holder. In addition, the holder can be displaced in the first direction to a position corresponding to the positional tolerances of the partner terminal and the connection portion. As a result, by simply bringing the partner terminal into contact with the contact portion and guiding the partner terminal into the partner terminal accommodation portion, the partner terminal can enter a state of being fastenable to the connection portion and the nut or the bolt, whereby it is possible to fasten the partner terminal and the connection portion with the bolt or the nut while absorbing the tolerance. Therefore, it is possible to employ a simpler structure for the tolerance absorption mechanism while more stably realizing electrical continuity between the partner terminal and the connection portion.

It is preferable that the electrically conductive member is constituted by a busbar, the connection portion is provided at one end of the busbar, and the bolt through hole extends in a longitudinal direction of the busbar. Since the electrically conductive member is constituted by a busbar and need only be provided with an elongated bolt insertion hole at one end, the structure of the electrically conductive member can be simplified and the number of components can be reduced.

It is preferable that the support portion includes a pair of guide rails that extend in the first direction and are arranged in parallel with a gap therebetween, the connection portion of the electrically conductive member is inserted from one end of the guide rails and disposed therein, and the holder engages with the guide rails so as to be displaceable in the first direction. By simply providing a pair of guide rails on the support portion and displaceably engaging the holder between the guide rails, a structure can be provided that can absorb the positional tolerances of the connection portion and the partner terminal in the first direction.

It is preferable that the nut or the bolt held by the holder is disposed below the connection portion of the electrically conductive member, and the contact portion and the partner terminal accommodation portion of the holder are arranged above the connection portion of the electrically conductive member. Since the nut or the bolt is disposed below the connection portion, and the contact portion and the partner terminal accommodation portion are arranged above the connection portion, the task of bringing the partner terminal into contact with the contact portion and the task of fastening the partner terminal to the connection portion with the nut or the bolt can be performed with good visibility, thereby improving workability.

It is preferable that in each of the pair of guide rails, a plurality of engaging projections that extend toward the other of the pair of guide rails and are capable of elastic deformation are arranged spaced apart from each other in the first direction, and the holder has a pair of claw portions configured to engage with the engaging projections of the guide rails. The holder displaced in the first direction to a position corresponding to the tolerance can be temporarily held by engagement between the plurality of engaging projections provided on the guide rails on both sides and the pair of claw portions provided on the holder. This prevents the holder from being displaced when the partner terminal and the connection portion are fastened with a bolt, thus improving the workability of the bolt fastening task.

Note that the plurality of engaging projections can be formed in any shape. For example, the plurality of engaging projections may be of a ratchet type that allows displacement only in the first direction from the other end to the one end of the guide rail due to elastic deformation of the claw portions, or may have a shape that allows displacement on both sides in the first direction due to elastic deformation of the claw portions.

It is preferable that the connection portion of the electrically conductive member has a wide bolt insertion hole that extends also in a second direction perpendicular to the first direction, the holder is attached to the support portion so as to be displaceable also in the second direction, the contact portion includes a first contact portion and a second contact portion, due to the partner terminal coming into contact with the first contact portion, the partner terminal is guided into the partner terminal accommodation portion in the first direction and the holder is displaced in the first direction, and due to the partner terminal coming into contact with the second contact portion, the partner terminal is guided into the partner terminal accommodation portion in the second direction and the holder is displaced in the second direction.

The holder has the first contact portion and the second contact portion, and due to the partner terminal coming into contact with the first contact portion, the holder is displaced in the first direction, and due to the partner terminal coming into contact with the second contact portion, the holder is displaced in the second direction. Furthermore, the partner terminal is guided into the partner terminal accommodation portion in both directions at the same time. This makes it possible to advantageously absorb the positional tolerances of the partner terminal and the connection portion not only in the first direction but also in the second direction, thereby improving the versatility of the terminal connection unit.

It is preferable that the holder includes a bottom wall configured to hold the nut or the bolt in the center of the bottom wall, a pair of first inclined surfaces that protrude upward as they extend outward in the first direction from side edges of the bottom wall that oppose each other in the first direction, and a pair of second inclined surfaces that protrude upward as they extend outward in the second direction from side edges of the bottom wall that oppose each other in the second direction, and in a height direction of the holder, the partner terminal accommodation portion and the connection portion accommodation portion are disposed between the nut or the bolt and lower ends of the first inclined surfaces and the second inclined surfaces.

By simply providing the pair of first inclined surfaces and the pair of second inclined surfaces on the bottom wall of the holder, it is possible to advantageously absorb the tolerances of the partner terminal and the connection portion on both sides in the first direction and the tolerances of the partner terminal and the connection portion on both sides in the second direction. Moreover, in the height direction of the holder, the partner terminal accommodation portion and the terminal portion accommodation portion can be arranged between the lower ends of the inclined surfaces and the nut or the bolt held by the holder, that is, at a position sandwiched vertically between the lower ends of the inclined surfaces and the nut or the bolt. As a result, the partner terminal and the connection portion can be quickly fastened also at a position corresponding to the tolerance, thereby improving workability.

It is preferable to further include the partner terminal included at one end of a partner-side busbar, in which the partner terminal includes a terminal portion having a size capable of being accommodated in the partner terminal accommodation portion, and a crank-shaped bent portion provided on another end of the partner-side busbar relative to the terminal portion, and the terminal portion is disposed below the other end of the partner-side busbar.

The partner terminal is constituted by the partner-side busbar, and the crank-shaped bent portion provided on the partner-side busbar causes the terminal portion accommodated in the partner terminal accommodation portion to be disposed lower than the other end of the partner-side busbar. As a result, when the above-mentioned mode in which the first/second contact portions include first/second inclined surfaces is adopted, the terminal portion needs to be displaced downward to absorb the tolerances. However, by providing the bent portion, it is possible to eliminate the need to displace the terminal portion downward to a portion located on the other end side of the partner-side busbar with respect to the bent portion. As a result, the terminal connection unit of the present embodiment can be applied without influencing the existing vehicle-mounted component to which the other end of the partner-side busbar is connected.

It is preferable that the coupling member is constituted by a busbar, the connection portion and one end in a length direction of the coupling portion are coupled to each other by a first pin, whereby the coupling member is capable of rotational displacement about a central axis of the first pin with respect to the connection portion, the partner terminal and another end in the length direction of the coupling member are coupled to each other by a second pin, whereby the coupling member is capable of rotational displacement about a central axis of the second pin with respect to the partner terminal, and due to an external force accompanying displacement of the partner terminal being exerted on the coupling member, the coupling member coupled to the partner terminal by the second pin is capable of rotational displacement about the central axis of the first pin with respect to the support portion main body.

The connection portion and one end in the length direction of the coupling member constituted by the busbar are coupled to each other by the first pin, and the partner terminal and the other end in the length direction of the coupling member are coupled to each other by the second pin. That is, it is sufficient to simply provide the coupling member, the connection portion, and the partner terminal with circular through holes through which the pin is inserted, and thus a case is avoided in which, for example, a through hole that is oval-shaped or the like is provided to absorb tolerances. This further suppresses the reduction in the amount of metal constituting each member in the coupling member, the connection portion, and the partner terminal, and improves electrical conductivity and rigidity compared to, for example, a case in which an oval-shaped through hole is provided. In particular, due to the one end in the length direction of the coupling member being subjected to rotational displacement about the central axis of the first pin, it is possible to displace the other end in the length direction of the coupling member so as to trace a circular arc. Therefore, the second pin provided at the other end in the length direction of the coupling member or the insertion hole through which the second pin is inserted can be displaced in two directions that are perpendicular to each other (e.g., the front-rear direction and the left-right direction). This makes it possible to absorb tolerances in two directions that are perpendicular to each other.

It is preferable to further include a partner-side busbar in which the partner terminal is formed at one end of the partner-side busbar, another end of the partner-side busbar being coupled to a third busbar, in which displacement of the partner-side busbar is allowed due to rotational displacement of the coupling member, a bolt through hole in the other end of the partner-side busbar and a bolt through hole in the third busbar are positionally aligned with each other, and the partner-side busbar and the third busbar are fixed to each other by bolt.

By coupling both ends in the length direction of the coupling member with the first and second pins, the other end of the partner-side busbar, one end of which is connected to the other end in the length direction of the coupling member, is able to move over a larger range. This allows for greater flexibility in selecting the coupling position between the partner-side busbar and the third busbar. In particular, by rotating the coupling member, the bolt insertion hole at the other end of the partner-side busbar can be easily positionally aligned with the bolt insertion hole in the third busbar, thereby stably realizing fixation of the partner-side busbar and the third busbar with a bolt.

### Details of Embodiments of the Present Disclosure

Specific examples of the terminal connection unit of the present disclosure will be described below with reference to the drawings. Note that the present disclosure is not limited to these examples, but is indicated by the claims, and all modifications within the scope and meaning equivalent to the claims are intended to be encompassed therein.

### First Embodiment

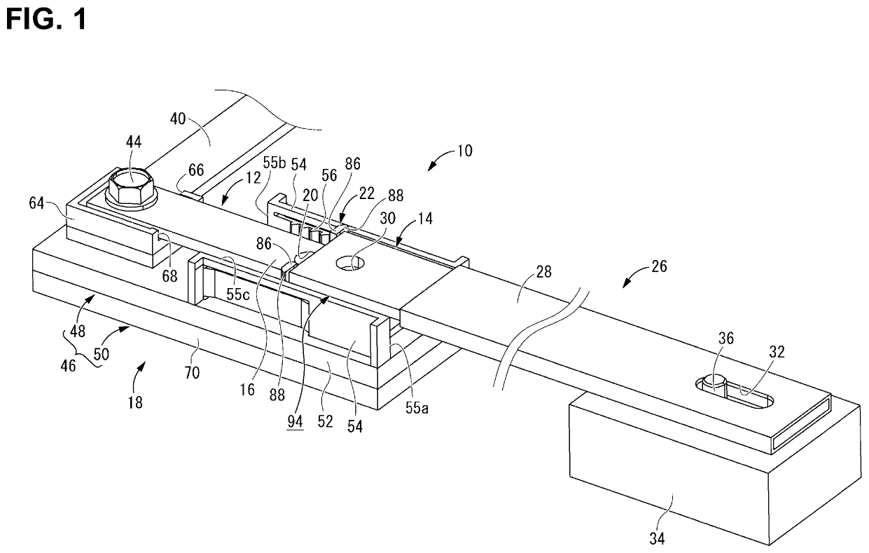

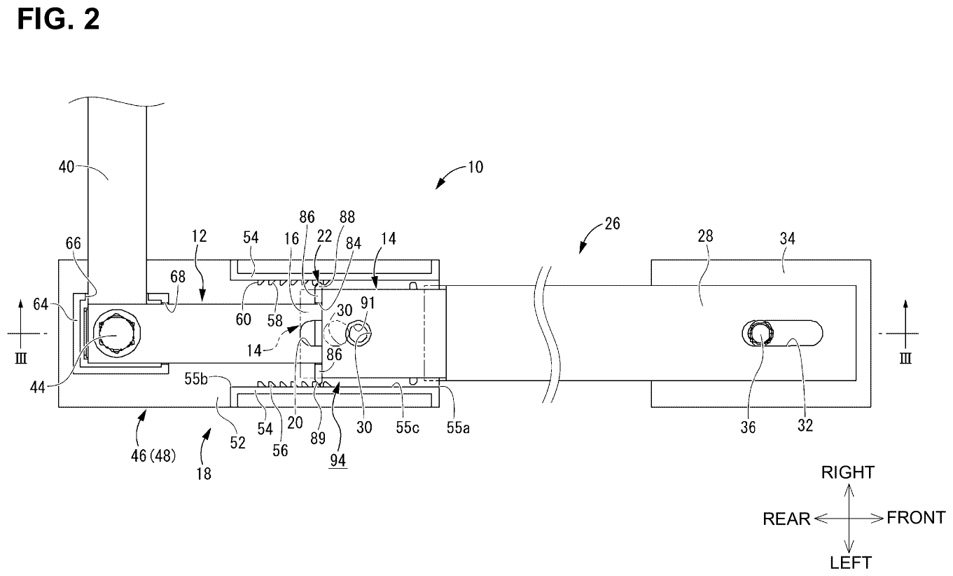

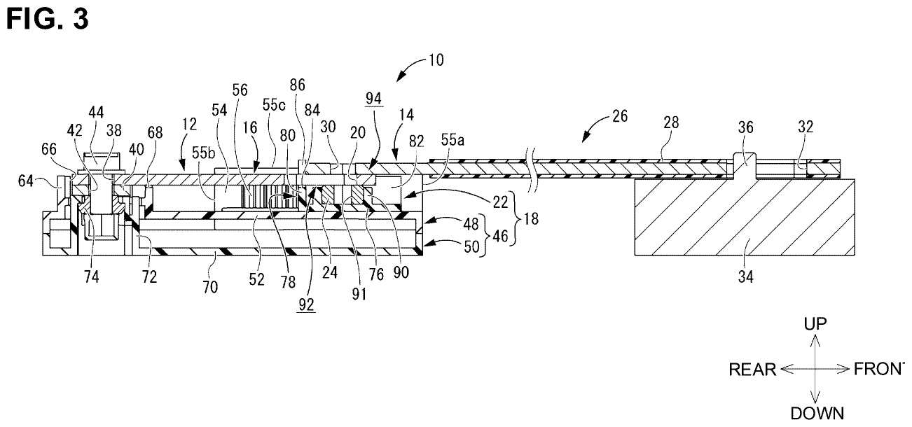

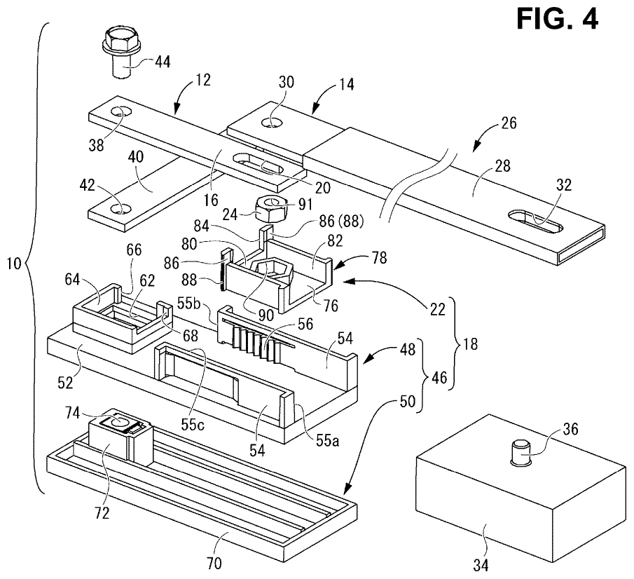

A terminal connection unit 10 according to a first embodiment of the present disclosure will be described below with reference to FIGS. 1 to 8. The terminal connection unit 10 is mounted in a vehicle such as an electric automobile or a hybrid vehicle, and connects an electrically conductive member 12 on a vehicle-mounted component such as a junction box to a partner terminal 14 extending from a partner-side device. Note that the terminal connection unit 10 can be disposed in any orientation, but in the following, upward is described as upward in FIG. 3, downward is described as downward in FIG. 3, frontward is described as rightward in FIG. 2, rearward is described as leftward in FIG. 2, leftward is described as downward in FIG. 2, and rightward is described as upward in FIG. 2. In the following description, the front-rear direction is referred to as a first direction in some cases. Furthermore, in the case of a plurality of identical components, reference numerals are given to only some of the components and the reference numerals are omitted for the other components in some cases.

### Terminal Connection Unit 10

The terminal connection unit 10 of the first embodiment includes an electrically conductive member 12 having a connection portion 16 to which a partner terminal 14 is connected, and a support portion 18 that supports the electrically conductive member 12 in a fixed manner. The connection portion 16 of the electrically conductive member 12 has an elongated bolt insertion hole 20 extending in the front-rear direction, which is the first direction. The support portion 18 has a holder 22 serving as a coupling member that is disposed below the connection portion 16 and is attached so as to be displaceable in a first direction (front-rear direction), and the holder 22 holds a nut 24. Note that FIGS. 1 to 3 show a state in which the connection portion 16 and the partner terminal 14 are connected to each other at a frontmost connection position among a plurality of connection positions provided on the terminal connection unit 10. In another embodiment, the holder may hold the bolt. For example, a mode may be adopted in which the head of the bolt is embedded in the holder and the shaft of the bolt protrudes upward.

### Partner Terminal 14

The partner terminal 14 is provided at one end (rear end) of a partner-side busbar 26 extending from the partner-side device, for example, although there is no limitation thereto. The partner-side busbar 26 is a thick busbar that is elongated in the first direction (front-rear direction), has a relatively large cross-sectional area, and has high deformation rigidity. Therefore, the tolerance of the partner-side busbar 26 tends to be relatively large. Note that the length dimension (front-rear dimension) of the partner-side busbar 26 is not limited, but may be about 2 m, for example.

The partner-side busbar 26 is covered, for example, over almost its entire length in the length direction with an insulating coating 28 made of synthetic resin, and the insulating coating 28 is peeled off at one end (rear end) to expose a metal plate that constitutes the partner-side busbar 26. A circular bolt insertion hole 30 is provided at the portion on the one end (rear end) of the partner-side busbar 26 where the insulating coating 28 is peeled off to expose the metal plate. Also, the other end (front end) of the partner-side busbar 26 is provided with a positioning hole 32 having a substantially elliptical shape extending in the front-rear direction, for example. The other end of the partner-side busbar 25 is placed on a terminal block 34 provided on the partner-side device, for example, and a positioning pin 36 protruding upward from the terminal block 34 is inserted into the positioning hole 32 at the other end (front end) of the partner-side busbar 26. The positioning pin 36 is movable within the positioning hole 32 extending in the front-rear direction, thereby allowing the partner-side busbar 26 to be displaced in the front-rear direction with respect to the terminal block 34.

### Conductive Member 12

The electrically conductive member 12 is constituted by a busbar extending in a first direction (front-rear direction), for example, and the connection portion 16 is provided at one end (front end) of the busbar. The bolt insertion hole 20 that passes through the busbar in the thickness direction (up-down direction) and extends in the longitudinal direction (front-rear direction) is formed in this connection portion 16. The dimension in the length direction (front-rear dimension) of the bolt insertion hole 20 is not limited, but when the fixing positions of the holder 22 are provided at a plurality of locations in the front-rear direction as described below, it is preferable that the bolt insertion hole 20 and an inner hole 91 of the nut 24 are in communication with each other in the up-down direction regardless of whether the holder 22 is at the frontmost or rearmost position. Also, a bolt insertion hole 38 is formed in the other end (rear end) of the electrically conductive member 12 (busbar). Note that in the first embodiment, the width dimension (left-right dimension) of the connection portion 16 is smaller than the width dimension (left right dimension) at the rear end of the partner-side busbar 26.

The other end (rear end) of the electrically conductive member 12 is connected to a busbar 40 extending from the vehicle-mounted component such as a junction box (not shown). A bolt insertion hole 42 is provided in an end of the busbar 40. The electrically conductive member 12 and the busbar 40 are overlaid on each other to positionally align the bolt insertion holes 38 and 42, and a bolt 44 inserted into the bolt insertion holes 38 and 42 is fastened to a later-described nut 74, whereby the electrically conductive member 12 and the busbar 40 are fixed to each other in an electrically continuous state. Note that the extension direction of the busbar 40 is not limited, but in the first embodiment, the busbar 40 extends in a direction intersecting the electrically conductive member 12. In the first embodiment in particular, the busbar 40 extends in a direction perpendicular to the electrically conductive member 12 (left-right direction). This also makes it possible to further suppress the dimension of the terminal connection unit 10 in the front-rear direction compared to the case where the busbar 40 extends in the front-rear direction, for example.

### Support Portion 18

The support portion 18 includes a support portion main body 46 made of synthetic resin, and the above-described holder 22 is attached to the support portion main body 46 so as to be displaceable with respect thereto in the first direction (front-rear direction). In the first embodiment, the support portion main body 46 is constituted by an upper main body 48 and a lower main body 50 that can be attached to and separated from each other in the up-down direction. Also, in the first embodiment, the support portion main body 46 has an approximately rectangular shape extending in the front-rear direction in a plan view, and both the upper main body 48 and the lower main body 50 are approximately rectangular members extending in the front-rear direction in a plan view.

That is, the upper main body 48 has an upper base portion 52 that is approximately rectangular and flat, and the upper base portion 52 has a front-rear dimension that is larger than its left-right dimension. A pair of guide rails 54 protruding upward are provided on both ends of the frontward portion of the upper base portion 52 in the left-right direction. Each of these guide rails 54 has a predetermined up-down dimension and front-rear dimension. In short, the support portion 18 (the upper main body 48 of the support portion main body 46) has a pair of guide rails 54 that extend in the first direction (front-rear direction) and are arranged in parallel with a gap therebetween in the left-right direction.

The guide rails 54 have a frontward opening 55a at their front ends, which is the other end, and a rear opening 55b at their rear ends, which is the one end, and the gap between the guide rails 54 in the left-right direction is in communication outward in the front-rear direction through the frontward opening 55a and rear opening 55b. Furthermore, the gap between the guide rails 54 in the left-right direction is in communication with the upper external space through an upward opening 55c at the upper ends of the guide rails 54. Also, in the first embodiment, the distance between the guide rails 54 in the left-right direction is approximately constant in the front-rear direction, and the distance between the guide rails 54 in the left-right direction is larger than the dimension in the width direction (dimension in the left-right direction) of the partner terminal 14.

Engaging projections 56 for engaging with a later-described claw portion 88 of the holder 22 are provided at the rearward portion of each guide rail 54. The engaging projections 56 protrude from each guide rail 54 toward the other guide rail 54, that is, protrude inward in the left-right direction, which is the direction in which the pair of guide rails 54 face each other. Also, each of the left and right guide rails 54 includes a plurality of engaging projections 56 spaced apart from each other in the first direction (front-rear direction). In the first embodiment, each engaging projection 56 has an approximately triangular cross-section, and the front surface of each engaging projection 56 is an inclined surface 58 that is inclined in a direction such that the protruding dimension of each engaging projection 56 inward in the left-right direction gradually decreases toward the front, and the rear surface of each engaging projection 56 is a vertical surface 60 that extends in a direction perpendicular to the front-rear direction.

In particular, in the first embodiment, the portion of each guide rail 54 where the engaging projections 56 are formed is made thinner than other portions of each guide rail 54 (e.g., the frontward portions of the guide rails 54), and on both the upper and lower sides of the portion where the engaging projections 56 are formed, a through groove is formed that passes through each guide rail 54 in the thickness direction (left-right direction) and extends in the front-rear direction. This allows the portion of each guide rail 54 where the engaging projections 56 are formed to be elastically deformable in the left-right direction.

As a result, as described below, the claw portions 88 of the holder 22 are locked on the vertical surfaces 60 of the engaging projections 56 between the guide rails 54, whereby the holder 22 is attached to the support portion main body 46. Then, the inclined surfaces 89 of the claw portions 88 come into contact with the inclined surfaces 58 of the engaging projections 56, and the claw portions 88 elastically deform the engaging projections 56 outward in the left-right direction, thereby enabling the holder 22 to be displaced between the guide rails 54 in a first direction, particularly from front to rear. Note that in the first embodiment, since the rear surfaces of the engaging projections 56 are the vertical surfaces 60, the holder 22 is prevented from moving frontward between the guide rails 54.

Also, a through window 62 that passes through the upper base portion 52 in the thickness direction (up-down direction) is formed in the central portion in the left-right direction at the rearward portion of the upper base portion 52. The through window 62 has an approximately rectangular shape in a plan view, and an approximately annular frame-shaped portion 64 that protrudes upward is provided at the peripheral edge of the through window 62. The rightward portion of this frame-shaped portion 64 is cut out so as to pass therethrough in the left-right direction, forming a rightward draw-out opening 66 from which the busbar 40 is drawn out to the right, as will be described later. The frontward portion of the frame-shaped portion 64 is cut out so as to pass therethrough in the front-rear direction, forming a frontward draw-out opening 68 from which the electrically conductive member 12 (busbar) is drawn out frontward, as will be described later. In the first embodiment, in the frame-shaped portion 64, the rightward draw-out opening 66 is cut out to a lower position than the frontward draw-out opening 68.

Furthermore, the lower main body 50 includes a lower base portion 70 that has an approximately rectangular flat plate shape, and the lower base portion 70 has approximately the same shape as the upper base portion 52 in a plan view. In the rearward portion of the lower base portion 70, at a position corresponding to the through window 62 of the upper base portion 52, an upward protruding portion 72 that protrudes upward is provided, and a nut 74 is fixed in a substantially embedded state at the upper end of the upward protruding portion 72.

The upper main body 48 and the lower main body 50 having such shapes are overlaid on each other in the up-down direction and are fixed to each other to form the support portion main body 46. In the first embodiment, the upper main body 48 and the lower main body 50 are fixed by press-fitting, that is, the downwardly protruding portion of the upper main body 48 is fitted in a substantially press-fit state into the upwardly open portion of the lower main body 50. When the upper main body 48 and the lower main body 50 are attached to each other, the upward protruding portion 72 protruding upward from the lower base portion 70 is inserted into the frame-shaped portion 64 through the through window 62 in the upper base portion 52. As a result, the nut 74 is provided inside the frame-shaped portion 64 of the support portion main body 46 in a state of being exposed upward. Note that the fixing method for the upper main body 48 and the lower main body 50 is not limited to press-fitting, and any conventional fixing method such as locking using a locking structure, adhesion, or welding can be used.

### Holder 22

The holder 22 has a substantially box-like shape that is open upward overall, and is made of synthetic resin. That is, the holder 22 includes a bottom wall 76 that is substantially rectangular in a plan view, and a peripheral wall 78 that protrudes upward from the outer peripheral edge of the bottom wall 76. In the first embodiment, the peripheral wall 78 is constituted by a rear wall 80 on the rear side and a pair of side walls 82 on both the left and right sides. In the first embodiment, the middle portion in the left-right direction of the rear wall 80 is formed with a dimension in the up-down direction that smaller than that of each of the side walls 82, that is, a notched recess that is recessed downward relative to each of the side walls 82 is formed at the upper end of the middle portion in the left-right direction of the rear wall 80.

The dimension in the left-right direction of this recess is slightly larger than the dimension in the left-right direction of the connection portion 16 of the electrically conductive member 12, and the recess in the rear wall 80 forms a rearward draw-out opening 84 from which the electrically conductive member 12 (busbar) is drawn out rearward, as described below. Also, in the first embodiment, the distance in the left-right direction between the outer surfaces of the side walls 82 is approximately equal to or slightly smaller than the dimension in the width direction (direction in the left-right direction) of the partner terminal 14, and the distance between the opposing surfaces of the side walls 82 is larger than the dimension in the width direction (dimension in the left-right direction) of the connection portion 16.

Furthermore, at both ends in the left-right direction of the rear wall 80 of the holder 22, there are provided contact portions 86 that come into contact with the partner terminal 14 when the connection portion 16 of the electrically conductive member 12 and the partner terminal 14 are fastened with a bolt, as described below. These contact portions 86 protrude upward relative to the side walls 82, and more specifically, protrude upward relative to the connection portion 16 when the connection portion 16 of the electrically conductive member 12 is accommodated in a later-described connection portion accommodation portion 92 of the holder 22. Both ends in the left-right direction of the rear wall 80 on which the contact portions 86 are provided protrude outward in the left-right direction relative to the side walls 82. As a result, a pair of claw portions 88 that engage with the engaging projections 56 provided on the guide rails 54 in the support portion main body 46 are provided at both ends in the left-right direction of the rear wall 80. The rear surfaces of these claw portions 88 are inclined surfaces 89 that are inclined in a direction such that the outward protruding dimension of each of the claw portions 88 in the left-right direction gradually decreases toward the rear.

Here, a nut accommodation portion 90 that protrudes upward is provided at approximately the central portion of the bottom wall 76. The nut accommodation portion 90 is cylindrical, and the outer shape of the nut accommodation portion 90 is substantially hexagonal to match the shape of the nut 24. The nut 24 is accommodated in the nut accommodation portion 90 and fixed as necessary, whereby the nut 24 is held by the holder 22. Note that in the first embodiment, when the nut 24 is accommodated in the nut accommodation portion 90, the upper end of the nut 24 protrudes upward relative to the nut accommodation portion 90.

When the connection portion 16 and the partner terminal 14 are fastened together by bolt as described below, the connection portion 16 of the electrically conductive member 12 is inserted into the holder 22, that is, between the left and right side walls 82, through the rearward draw-out opening 84 in the rear wall 80 of the holder 22, and is overlaid on the upper end of the nut 24. In short, the nut 24 held by the holder 22 is disposed below the connection portion 16 of the electrically conductive member 12. As a result, the elongated bolt insertion hole 20 provided in the connection portion 16 and the inner hole 91 of the nut 24 are in communication with each other in the up-down direction. That is, the connection portion accommodation portion 92 that accommodates the connection portion 16 so as to be fastenable to the nut 24 is formed by the space that is above the nut accommodation portion 90 in the holder 22 and between the opposing surfaces of the side walls 82.

As will be described later, when the connection portion 16 and the partner terminal 14 are fastened to each other by bolt, the partner terminal 14 is inserted from the front through the frontward opening 55a of the guide rails 54, comes into contact with the contact portions 86 in the holder 22, and is overlaid and placed on the upper surface of the connection portion 16. Accordingly, when the holder 22 is attached to the support portion main body 46, a partner terminal accommodation portion 94 for accommodating the partner terminal 14 is formed by the space that is in front of the contact portions 86 on the holder 22 and between the opposing surfaces of the guide rails 54. In short, the contact portions 86 and the partner terminal accommodation portion 94 of the holder 22 are arranged above the connection portion 16 of the electrically conductive member 12.

### Method for Assembling Terminal Connection Unit 10

Hereinafter, a specific example of a method for assembling the terminal connection unit 10 will be described. Note that the method for assembling the terminal connection unit 10 is not limited to the embodiment described below.

First, the upper main body 48 and the lower main body 50 are overlaid on each other in the up-down direction and fixed to each other. This completes the support portion main body 46. The nut 24 is accommodated in the nut accommodation portion 90 of the holder 22 and fixed as necessary, whereby the nut 24 is held by the holder 22. Thereafter, the holder 22 holding the nut 24 is inserted from the front through the frontward opening 55a of the guide rails 54 in the support portion main body 46, and thus the inclined surfaces 58 of the frontmost engaging projections 56 of the guide rails 54 and the inclined surfaces 89 of the claw portions 88 of the holder 22 come into contact with each other in the front-rear direction. Then, by pushing the holder 22 rearward into the support portion main body 46, the engaging projections 56 elastically deform outward in the left-right direction, allowing the holder 22 to be displaced rearward. In addition, the claw portions 88 pass over the engaging projections 56, causing the engaging projections 56 to elastically restore their original shapes, and the claw portions 88 are locked to the vertical surfaces 60 of the engaging projections 56. As a result, the holder 22 is attached to the support portion main body 46 in a state of being located at the frontmost position, and the support portion 18 is completed.

Note that the holder 22 may be inserted into the support portion main body 46 from above through the upward opening 55c between the guide rails 54, and the holder 22 may be attached at a predetermined position on the support portion main body 46 by inserting the claw portions 88 of the holder 22 between adjacent engaging projections 56 in the front-rear direction.

Next, at the rearward portion of the support portion 18, the left end of the busbar 40 extending from the vehicle-mounted component such as a junction box is inserted into the frame-shaped portion 64 through the rightward draw-out opening 66 in the frame-shaped portion 64, and the left end of the busbar 40 is placed on the upward protruding portion 72 located within the frame-shaped portion 64. Thereafter, the other end (rear end) of the electrically conductive member 12 (busbar) is inserted into the frame-shaped portion 64 through the frontward draw-out opening 68 in the frame-shaped portion 64 and is placed on the left end of the busbar 40. This allows the bolt insertion hole 38 at the rear end of the electrically conductive member 12 (busbar), the bolt insertion hole 42 at the left end of the busbar 40, and the inner hole of the nut 74 disposed on the upward protruding portion 72 to be brought into communication with each other in the up-down direction, and the bolt 44 is inserted through these and fastened to the nut 74. As a result, the left end of the busbar 40 and the rear end of the electrically conductive member 12 (busbar) are fixed in a mutually overlapping state at the rearward portion of the support portion 18.

Furthermore, by fixing the electrically conductive member 12 (busbar) in this manner, the connection portion 16 at one end (front end) of the electrically conductive member 12 (busbar) is inserted and accommodated in the connection portion accommodation portion 92 in the holder 22 through the rear opening 55b on the one end side of the guide rails 54 and the rearward draw-out opening 84 in the holder 22, and the connection portion 16 is placed on the nut 24 held by the holder 22. As a result, the bolt insertion hole 20 in the connection portion 16 and the inner hole 91 of the nut 24 are in communication with each other in the up-down direction, and in this state, the terminal connection unit 10 is completed.

### Method for Connecting Connection Portion 16 and Partner Terminal 14

Hereinafter, a specific example of a method for connecting the connection portion 16 of the electrically conductive member 12 and the partner terminal 14 in the terminal connection unit 10 assembled as described above will be described. Note that the method for connecting the connection portion 16 and the partner terminal 14 is not limited to the mode described below.

The partner terminal 14 at one end (rear end) of the partner-side busbar 26 is inserted from the front through the frontward opening 55a between the guide rails 54 and overlaid on the connection portion 16 of the electrically conductive member 12, and the positioning pin 36 protruding upward from the terminal block 34 of the partner-side device, for example, is inserted into the positioning hole 32 at the other end (front end). However, if the partner-side busbar 26 is long, for example, about 2 m, performing work on both ends of the partner-side busbar 26 simultaneously is not easy due to the problem of the tolerance of the partner-side busbar 26, which tends to be relatively large, for example.

In view of this, first, the front end of the partner-side busbar 26 is placed on the terminal block 34 of the partner-side device, and the positioning pin 36 of the terminal block 34 is inserted into the positioning hole 32. Thereafter, the rear end of the partner-side busbar 26 is inserted from the front through the frontward opening 55a between the pair of guide rails 54, or from above through the upward opening 55c, and is overlaid from above on the connection portion 16 of the electrically conductive member 12 accommodated in the connection portion accommodation portion 92 of the holder 22. In short, the partner terminal 14 is accommodated in the partner terminal accommodation portion 94, which is the space that is between the pair of guide rails 54 and in front of the contact portion 86.

Note that FIGS. 1 to 3 show, for example, a case in which manufacturing error with respect to a reference dimension of the partner-side busbar 26 is relatively small, and show a state in which, when the positioning pin 36 is inserted into the positioning hole 32, the partner terminal 14 is accommodated in the partner terminal accommodation portion 94 without a problem, and the partner terminal 14 is overlaid from above on the connection portion 16 of the electrically conductive member 12. When the partner terminal 14 is overlaid on the connection portion 16 from above, if the rear end of the partner terminal 14 does not come into contact with the contact portions 86 protruding upward on the holder 22, that is, if there is a gap in the front-rear direction between the rear end of the partner terminal 14 and the contact portions 86, the partner-side busbar 26 is displaced rearward with respect to the terminal block 34. As a result, the rear end of the partner terminal 14 and the contact portions 86 on the holder 22 come into contact with each other in the front-rear direction, and the bolt insertion hole 30 provided in the partner terminal 14 and the inner hole 91 of the nut 24 held by the holder 22 are positionally aligned in the up-down direction. Then, a bolt (not shown) is inserted through the bolt insertion hole 30 in the partner terminal 14 and the bolt insertion hole 20 in the connection portion 16 and is fastened to the nut 24 held by the holder 22, thereby completing the connection between the connection portion 16 and the partner terminal 14.

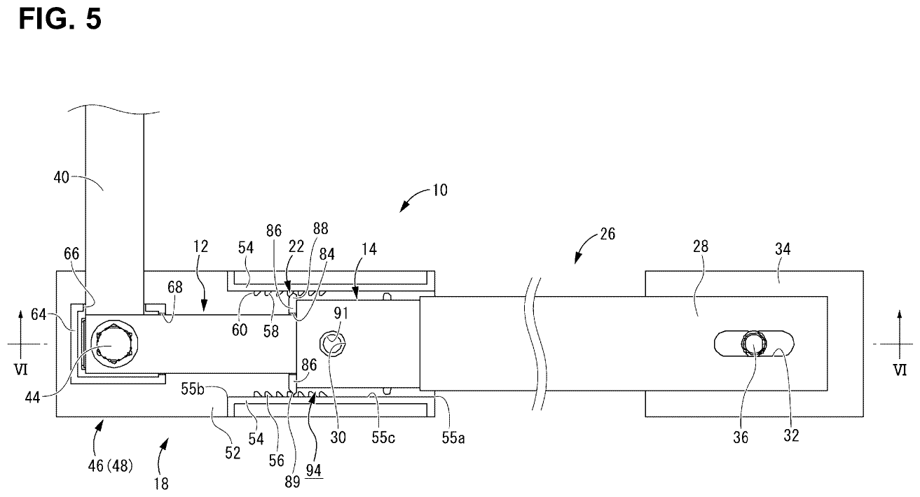

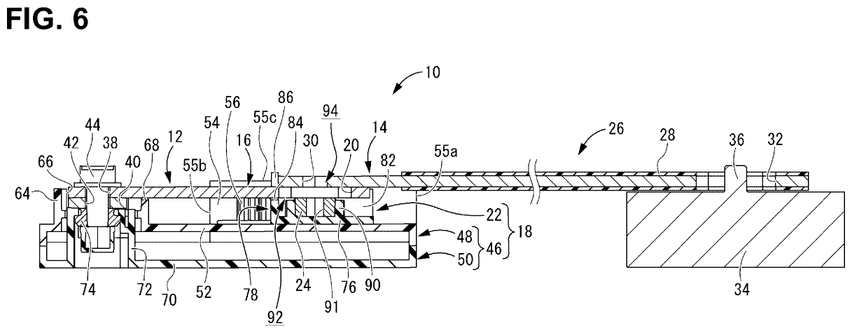

Next, referring to FIGS. 5 and 6, a case will be described in which manufacturing error with respect to the reference dimension of the partner-side busbar 26 is relatively large, and for example, the partner-side busbar 26 is longer than that shown in FIGS. 1 to 3. In this case, if the holder 22 is attached at the frontmost position relative to the support portion 18 as shown in FIGS. 1 to 3, even if an attempt is made to accommodate the partner terminal 14 in the partner terminal accommodation portion 94 after the front end of the partner-side busbar 26 is placed on the terminal block 34 of the partner-side device and the positioning pin 36 in terminal block 34 is inserted into the positioning hole 32, for example, the rear end of the partner terminal 14 will be placed on the contact portions 86, as indicated by the two-dot chain line in FIG. 2, because the partner-side busbar 26 is long.

In such a case, with the rear end of the partner terminal 14 placed on the contact portions 86, for example, the positioning pin 36 is removed from the positioning hole 32, and the partner-side busbar 26 is moved frontward relative to the terminal block 34. This causes the rear end of the partner terminal 14 to move frontward relative to the contact portions 86, allowing the partner terminal 14 to be accommodated in the partner terminal accommodation portion 94 and the contact portions 86 to come into contact with the rear end of the partner terminal 14 in the front-rear direction. Note that at this time, the positioning pin 36 is in a position, for example, shifted rearward relative to the positioning hole 32.

Therefore, next, with the contact portions 86 and the rear end of the partner terminal 14 in contact in the front-rear direction, the partner-side busbar 26 is displaced by being pushed rearward with respect to the terminal block 34. As a result, the contact portions 86 are pushed rearward by the rear end of the partner terminal 14, and the inclined surfaces 89 of the claw portions 88 provided on the holder 22 come into contact with the inclined surfaces 89 of the engaging projections 56 on the support portion 18 side, causing the engaging projections 56 to elastically deform outward in the left-right direction and allowing the partner terminal 14 and the holder 22 to be displaced rearward (in the first direction). Thereafter, as shown in FIGS. 5 and 6, the partner-side busbar 26 is displaced rearward by a predetermined distance as the engaging projections 56 repeatedly undergo elastic deformation and elastic restoration deformation. As a result, at one of the plurality of connection positions provided in the front-rear direction in the holder, for example, at a connection position in the middle portion in the front-rear direction, the claw portions 88 are locked to the vertical surfaces 60 of the engaging projections 56, and the positioning pin 36 enters the positioning hole 32.

That is, when the partner terminal 14 is accommodated in the partner terminal accommodation portion 94, the bolt insertion hole 30 of the partner terminal 14, the bolt insertion hole 20 of the connection portion 16, and the inner hole 91 of the nut 24 are in communication with each other, but the other end of the partner-side busbar 26 is not connected correctly. Thus, the partner terminal 14 can be brought into contact with the contact portions 86 of the holder 22 and pushed rearward to bring the other end of the partner-side busbar 26 into a state of being connected correctly. As a result, both ends of the partner-side busbar 26 can be connected correctly, and in this state, a bolt (not shown) is inserted through the bolt insertion hole 30 of the partner terminal 14 and the bolt insertion hole 20 of the connection portion 16 and fastened to the nut 24, thereby completing the connection between the partner terminal 14 and the connection portion 16. In this manner, in the first embodiment, the coupling member that couples the partner terminal 14 and the connection portion 16 includes the holder 22, and the support portion 18 has the coupling member (holder 22). When an external force accompanying the downward displacement of the partner terminal 14 is applied to the holder 22, the holder 22 can be displaced rearward with respect to the support portion main body 46 of the support portion 18.

Note that the rearward movement of the partner-side busbar 26 can end when the positioning pin 36 enters the positioning hole 32. However, when the positioning pin 36 is in the positioning hole 32, both ends of the partner-side busbar 26 are connected correctly. Therefore, even if, for example, the partner-side busbar 26 is further displaced rearward after the positioning pin 36 enters the positioning hole 32, there is no problem, and the partner terminal 14 and the connection portion 16 can be fastened by bolt at any position desired by the worker.

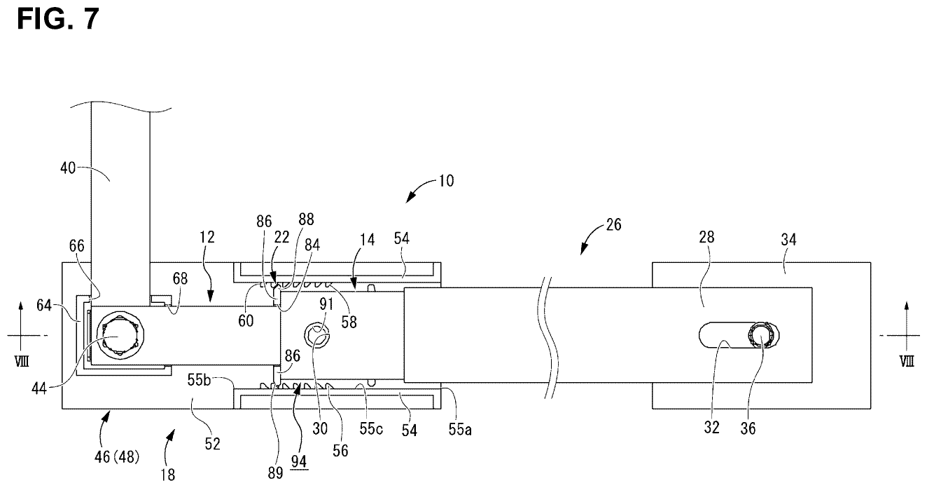

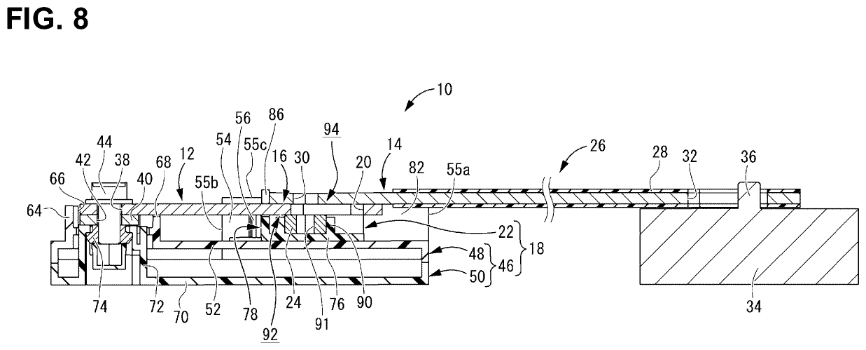

Next, referring to FIGS. 7 and 8, a case will be described in which manufacturing error with respect to the reference dimensions of the partner-side busbar 26 is even greater, and for example, the partner-side busbar 26 is even longer than that shown in FIGS. 5 and 6. In such a case, the basic connection procedure is the same as that described with reference to FIGS. 5 and 6.

That is, when the holder 22 is at the position shown in FIGS. 1 to 3 or FIGS. 5 and 6, by pushing the partner-side busbar 26 rearward while the partner terminal 14 is in contact with the contact portions 86 on the holder 22, the partner terminal 14 and the holder 22 are displaced in the first direction to the position shown in FIGS. 7 and 8, and the positioning pin 36 is inserted into the positioning hole 32. As a result, both ends of the partner-side busbar 26 are connected in the correct state, and the connection between the partner terminal 14 and the connection portion 16 is completed by inserting a bolt (not shown) through the bolt insertion hole 30 of the partner terminal 14 and the bolt insertion hole 20 of the connection portion 16 and fastening the bolt to the nut 24.

According to the terminal connection unit 10 of the first embodiment, when connecting the partner terminal 14 and the connection portion 16 of the electrically conductive member 12, the partner terminal 14 can be guided into the partner terminal accommodation portion 94 due to the partner terminal 14 coming into contact with the contact portions 86 in the holder 22 that holds the nut 24. When the partner terminal 14 is located in the partner terminal accommodation portion 94, the bolt insertion hole 30 of the partner terminal 14, the bolt insertion hole 20 of the connection portion 16, and the inner hole 91 of the nut 24 are in communication with each other in the up-down direction, and the partner terminal 14 and the connection portion 16 can be connected by inserting a bolt (not shown) into the bolt insertion holes 30 and 20 and fastening the bolt to the nut 24.

In particular, even if, for example, the partner-side busbar 26 having the partner terminal 14 is long and the tolerance tends to be relatively large, by adopting a structure in which the partner terminal 14 is brought into contact with the contact portions 86 of the holder 22 that holds the nut 24 and the partner terminal 14 and the holder 22 are displaced integrally, it is possible to route the partner-side busbar 26 at the correct position while absorbing the tolerance of the partner-side busbar 26. This makes it possible to realize tolerance absorption with a simpler structure without providing a braided wire or laminated busbar in the electrically conductive member in the terminal connection unit as in the conventional structure. Also, if the structure of the first embodiment is adopted, there is no need to accurately position both ends of the long partner-side busbar 26 when connecting the partner terminal 14 and the connection portion 16, and the positions of the holder 22 and the nut 24 can be adjusted according to the length of the partner-side busbar 26, thereby improving the assembly workability.

Note that the technical idea of the first embodiment of the present disclosure is that by bringing the partner terminal 14 into contact with the contact portions 86 of the holder 22 and pressing the holder 22 with the partner terminal 14, the position of the nut 24 can be adjusted according to the length of the partner-side busbar 26 to absorb the tolerance of the partner-side busbar 26, and there is no limitation on the specific structure and shape of the other end (front end) of the partner-side busbar 26.

The electrically conductive member 12 is constituted by a busbar, and a bolt insertion hole 20 extending in the longitudinal direction of the busbar is formed in the connection portion 16 at one end of the busbar. In particular, in the first embodiment, the bolt insertion hole 20 and the inner hole 91 of the nut 24 are in communication with each other in the up-down direction no matter where the holder 22 is located in the front-rear direction. As a result, by bringing the partner terminal 14 into contact with the contact portions 86 of the holder 22, the bolt insertion hole 30 of the partner terminal 14 and the inner hole 91 of the nut 24 are positionally aligned, and as a result, the bolt insertion hole 20 of the connection portion 16 and the bolt insertion hole 30 of the partner terminal 14 can be brought into communication with each other. Accordingly, by forming the bolt insertion hole 20 in the connection portion 16 in an elongated hole shape, communication between the bolt insertion holes 20 and 30 and the inner hole 91 of the nut 24 can be easily realized.

The support portion 18 includes guide rails 54 extending in a first direction (front-rear direction), and the holder 22 is capable of being displaced along the guide rails 54 in the first direction (front-rear direction). This makes it possible to realize a tolerance absorption structure in the longitudinal direction of the elongated partner-side busbar 26, which is prone to tolerance problems, and this makes it possible to reduce the size of terminal connection unit 10 in the left-right direction.

The connection portion 16 of the electrically conductive member 12 is placed above the nut 24, the contact portions 86 of the holder 22 protrude above the connection portion 16, and the partner terminal accommodation portion 94 is constituted by including the space that is above the connection portion 16 and in front of the contact portions 86. This allows the partner terminal 14 to be accommodated in the partner terminal accommodation portion 94 from above or from the front, improving work efficiency by making it possible for one person to work on even the elongated partner-side busbar 26, for example. In addition, the task of accommodating the partner terminal 14 in the partner terminal accommodation portion 94, the task of fastening the connection portion 16 and the partner terminal 14 with a bolt, and the like can be performed with good visibility.

The pair of guide rails 54 have engaging projections 56, and the holder 22 has claw portions 88 that can engage with the engaging projections 56. In particular, the engaging projections 56 are provided at a plurality of locations in the front-rear direction, and the holder 22 can be fixed at a plurality of locations between the guide rails 54 in the front-rear direction. This prevents the holder 22 from being unintentionally displaced in the front-rear direction when the holder 22 is displaced in the front-rear direction according to the length dimension of the partner-side busbar 26, and makes it possible to stably perform the task of fixing the partner terminal 14 and the connection portion 16 to each other with a bolt. In particular, in the first embodiment, although the holder 22 can move from front to rear between the guide rails 54, it is not possible to move from rear to front, and thus unintended displacement of the holder 22 can be more reliably prevented.

### Second Embodiment

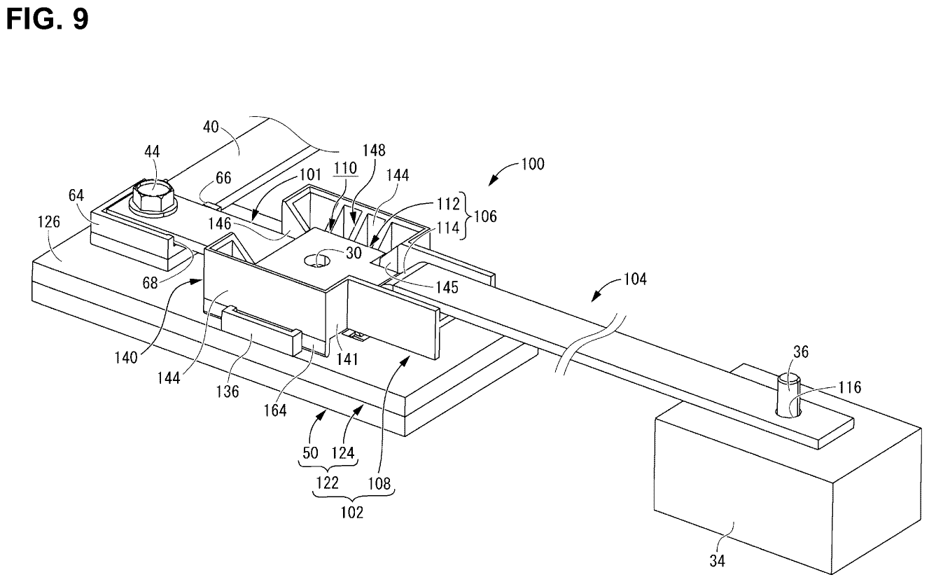

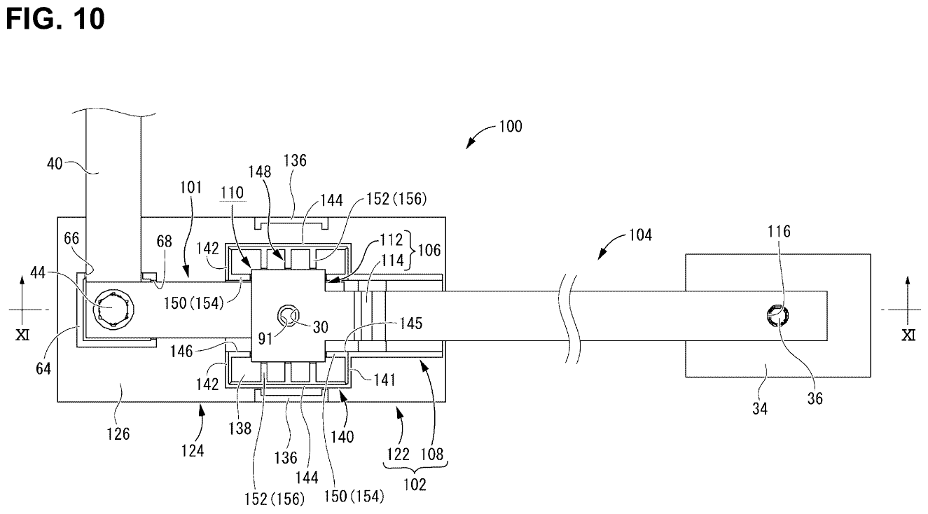

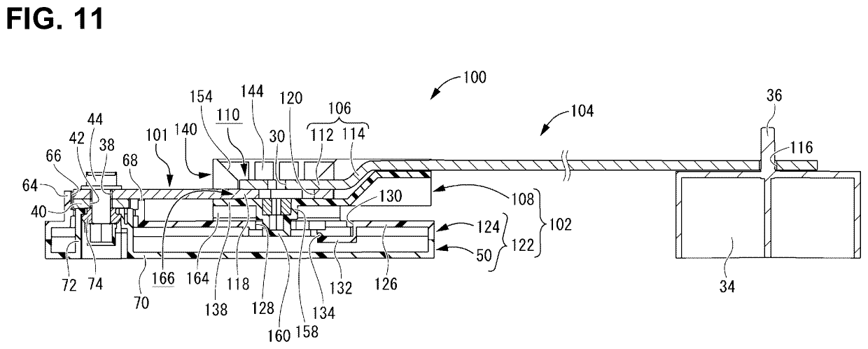

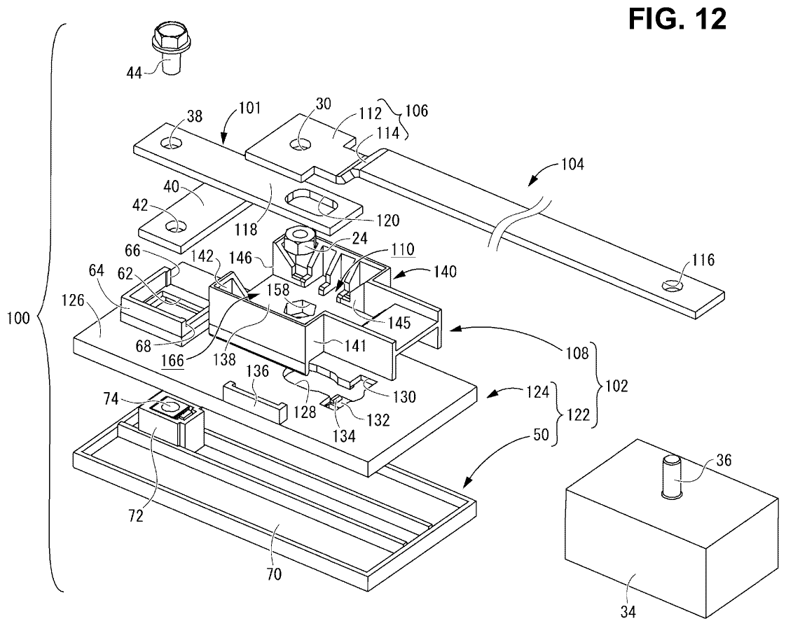

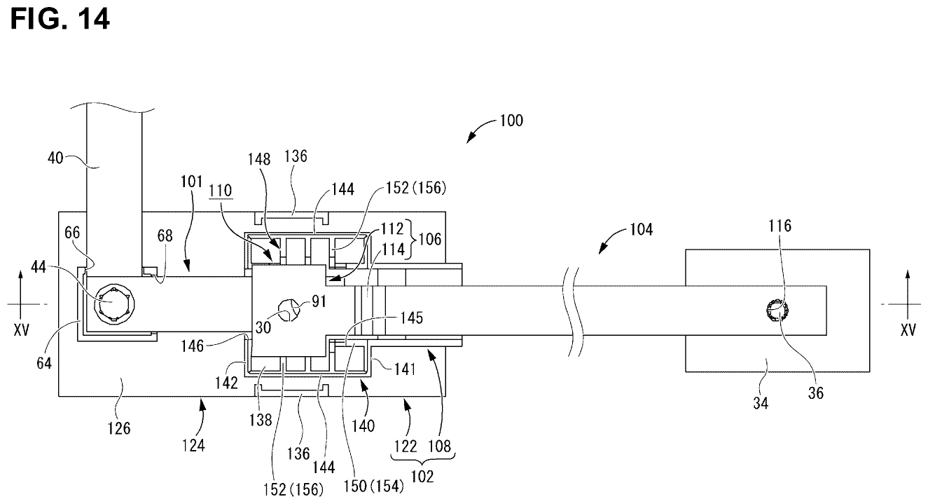

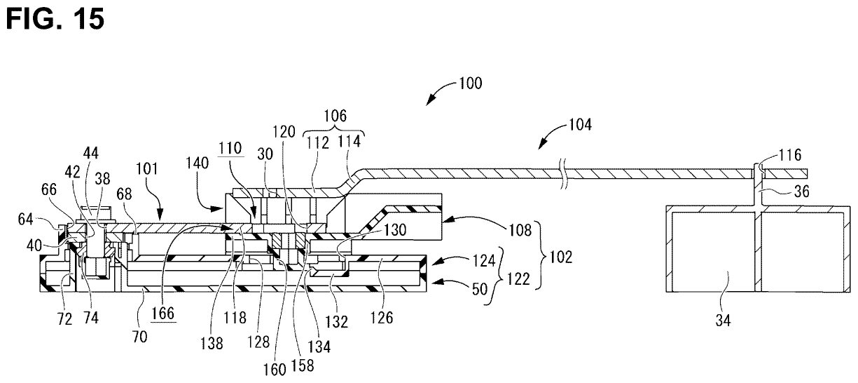

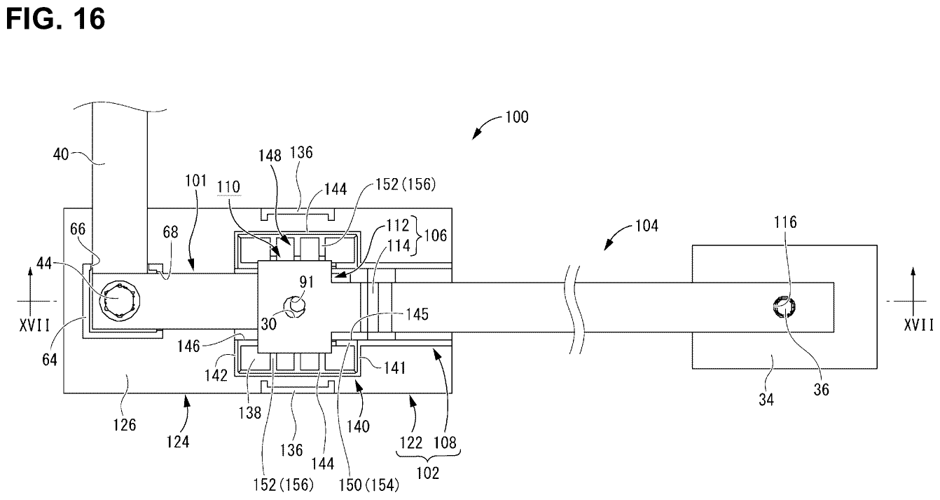

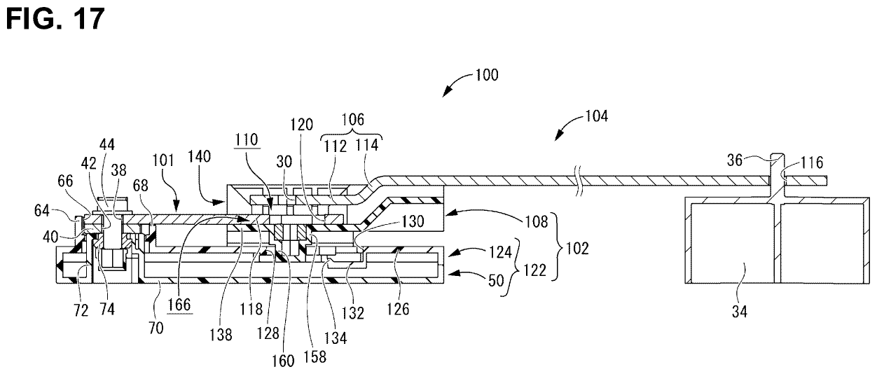

Next, a terminal connection unit 100 according to a second embodiment of the present disclosure will be described with reference to FIGS. 9 to 17. In the second embodiment as well, an electrically conductive member 101 that is substantially the same as that in the first embodiment is used, but the structure of a support portion 102 that supports the electrically conductive member 101 in a fixed manner and a partner-side busbar 104 serving as a busbar are different from those in the first embodiment. Hereinafter, the differences between the terminal connection unit 100 and the first embodiment will be mainly described, components and parts that are substantially the same as those in the first embodiment are denoted by reference symbols that are the same as in the first embodiment in the drawings, and detailed description thereof is omitted. Note that FIGS. 9 to 11 show a state in which both ends of the partner-side busbar 104 are correctly connected, FIGS. 14 and 15 show a state in which a partner terminal 106 provided on the partner-side busbar 104 has started to be accommodated in a partner terminal accommodation portion 110 provided in a holder 108 serving as a coupling member, and FIGS. 16 and 17 show a state in which the partner terminal 106 has been further accommodated in the partner terminal accommodation portion 110 compared to FIGS. 14 and 15.

### Partner Terminal 106

The terminal connection unit 100 of the second embodiment includes a partner terminal 106 (partner-side busbar 104). In the second embodiment as well, the partner-side busbar 104 is assumed to be a thick busbar that is elongated in the first direction (front-rear direction) and has a relatively large cross-sectional area, for example. The partner terminal 106 at one end (rear end) of the partner-side busbar 104 includes a terminal portion 112 that extends in the horizontal direction (direction perpendicular to the up-down direction) and a bent portion 114 that is bent into a crank shape on the other end (front end) side relative to the terminal portion 112. In the second embodiment, the dimension in the left-right direction of the terminal portion 112 is larger than the dimension in the left-right direction of the portion of the partner-side busbar 104 in front of the terminal portion 112. As a result, the terminal portion 112 has a substantially square shape in a plan view or a substantially rectangular shape in which the dimension in the left-right direction is greater than the dimension in the front-rear direction. A circular bolt insertion hole 30 passing through the terminal portion 112 in the up-down direction is formed in the approximate central portion of the terminal portion 112. In addition, by providing the bent portion 114 in front of the terminal portion 112, the terminal portion 112 at the rear end of the partner-side busbar 104 is disposed lower than the other end side (front end side).

Note that the other end (front end) of the partner-side busbar 104 is provided with an approximately circular positioning hole 116, through which a positioning pin 36 protruding upward from a terminal block 34 provided on the partner-side device is inserted.

### Electrically Conductive Member 101

In the electrically conductive member 101 as well, a bolt insertion hole 120 passing through the electrically conductive member 101 in the thickness direction (up-down direction) is formed in the connection portion 118 at the front end of the electrically conductive member 101. The bolt insertion hole 120 in the second embodiment has a larger dimension in the width direction (dimension in the left-right direction) than the bolt insertion hole 20 in the first embodiment, and although the first direction (front-rear direction) is the longitudinal direction overall, the bolt insertion hole 120 has a wide shape that extends also in a second direction (left-right direction) perpendicular to the first direction. Note that, similarly to the first embodiment, a busbar 40 extending from an vehicle-mounted component such as a junction box (not shown) is connected to the rear end of the electrically conductive member 101.

### Support Portion 102

The support portion 102 includes a support portion main body 122 to which the holder 108 is attached. The support portion main body 122 is constituted by an upper main body 124 and a lower main body 50, similarly to the first embodiment. Note that the lower main body 50 has the same structure as in the first embodiment, and therefore description thereof is omitted.

The upper main body 124 includes an upper base portion 126 in the shape of an approximately rectangular flat plate, and a through hole 128 passing through in the thickness direction (up-down direction) is formed in the frontward portion of the upper base portion 126. The longitudinal direction of the through hole 128 is the first direction (front-rear direction) overall, but the through hole 128 has a wide shape that extends also in the second direction (left-right direction). An approximately rectangular locking plate insertion hole 130 that extends in the left-right direction and passes through in the up-down direction is formed in the frontward portion of the through hole 128 so as to be continuous with the through hole 128. The locking plate insertion hole 130 is formed with a size that allows a later-described locking plate 162 provided on the holder 108 to be inserted therethrough.

Also, an elastic piece 132 that protrudes downward and protrudes frontward from the downward protruding end is provided on the inner peripheral edge at the front of the locking plate insertion hole 130. The elastic piece 132 is capable of elastic deformation in the up-down direction, and the front end of the elastic piece 132 is provided with a pass-over projection 134. Note that at both ends in the left-right direction of the upper surface of the upper base portion 126, displacement restriction portions 136 that protrude upward are provided at positions in the front-rear direction that are approximately equal to the through hole 128. As a result, if the holder 108 is excessively displaced in the left right direction with respect to the support portion main body 122, the displacement restriction portions 136 come into contact with the holder 108, thereby restricting further displacement in the left-right direction of the holder 108. Note that, similarly to the first embodiment, a through window 62 and a frame-shaped portion 64 are provided in the rearward portion of the upper base portion 126. Also, the upper main body 124 and the lower main body 50 are fixed to each other by press-fitting in the same manner as in the first embodiment, whereby the support portion main body 122 is formed.

### Holder 108

The holder 108 has an approximately box-like shape that opens upward overall, and includes a bottom wall 138 that is approximately rectangular in a plan view, and a peripheral wall 140 that protrudes upward from the outer peripheral edge of the bottom wall 138. Note that the bottom wall 138 has a rearward portion with a larger dimension in the width direction (dimension in the left right direction) than a frontward portion in correspondence with the shape of the partner terminal 106. In the second embodiment, the peripheral wall 140 is constituted by a front wall 141 on the front side, a rear wall 142 on the rear side, and a pair of side walls 144 on both the left and right sides. A frontward draw-out opening 145 and a rearward draw-out opening 146 that have cut-out shapes passing through in the front-rear direction are formed in the middle portion in the left-right direction of the front wall 141 and the rear wall 142. In the second embodiment, contact portions 148 that come into contact with the partner terminal 106 when the partner terminal 106 and the connection portion 118 are connected to each other are formed on the front wall 141, the rear wall 142, and the side walls 144.

Specifically, the contact portions 148 include first contact portions 150 provided on the front wall 141 and the rear wall 142 to guide displacement of the holder 108 in the first direction (front-rear direction), and second contact portions 152 provided on the side walls 144 to guide displacement of the holder 108 in the second direction (left-right direction). More specifically, the first contact portions 150 are approximately plate-shaped portions that protrude inward in the front-rear direction from both sides in the left-right direction of the frontward draw-out opening 145 and the rearward draw-out opening 146 in the front wall 141 and the rear wall 142, and the upper end surfaces of the first contact portions 150 are first inclined surfaces 154 that are inclined in a direction such that the dimension in the up-down direction of the first contact portions 150 increases (protrudes further upward) as they extend outward in the first direction (front-rear direction). Also, the second contact portions 152 are approximately plate-shaped portions that protrude inward in the left-right direction at a plurality of locations spaced apart in the front-rear direction on the side walls 144, and the upper end surfaces of the second contact portions 152 are second inclined surfaces 156 that are inclined in a direction such that the dimension in the up-down direction of the second contact portions 152 increases (protrudes further upward) as they extend outward in the second direction (left-right direction). At the lower end portions of the first contact portions 150 and the second contact portions 152, a region surrounded by the first contact portions and the second contact portions 152 and having a substantially rectangular shape in a plan view is a partner terminal accommodation portion 110.

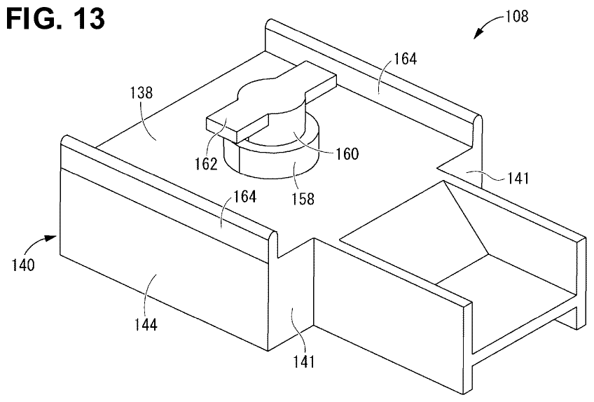

Note that an approximately cylindrical nut accommodation portion 158 is provided in the approximately central portion of the bottom wall 138 so as to protrude downward, and the inner hole of this nut accommodation portion 158 is open in the upper surface of the bottom wall 138. The nut 24 is accommodated in the nut accommodation portion 158 from above and fixed as necessary, whereby the nut 24 is held by the holder 108. As shown in FIG. 13, the locking plate 162 is integrally formed with the nut accommodation portion 158 via the coupling portion 160, and the locking plate 162 has an approximately rectangular plate shape protruding from the lower end of the coupling portion 160 on both sides in the left-right direction.

Furthermore, each side wall 144 of the holder 108 includes a contact portion 164 that protrudes downward and comes into contact with the upper surface of the support portion main body 122 (the upper surface of the upper base portion 126) when the holder 108 is attached to the support portion main body 122. Each contact portion 164 is provided over the entire length in the front-rear direction of a side wall 144, and the dimension in the width direction (dimension in the left-right direction) of the protruding leading end of the contact portion 164 is reduced, thereby reducing friction between the contact portion 164 and the support portion main body 122 when the holder 108 is displaced.

When the connection portion 118 and the partner terminal 106 are fastened together by bolt as described below, the connection portion 118 of the electrically conductive member 101 is inserted into the holder 108 through the rearward draw-out opening 146 in the rear wall 142 of the holder 108 and is overlaid on the bottom wall 138. This allows the bolt insertion hole 120 provided in the connection portion 118 and the inner hole 91 of the nut 24 accommodated in the nut accommodation portion 158 in the bottom wall 138 to be in communication with each other in the up-down direction. Accordingly, in the second embodiment, a connection portion accommodation portion 166 is formed between the first contact portions 150 that constitute the frontward draw-out opening 145 and the rearward draw-out opening 146 in the holder 108 in the left-right direction. In particular, in the second embodiment, the connection portion accommodation portion 166 is provided between the nut 24 and the lower ends of the first inclined surfaces 154 and the second inclined surfaces 156, in the height direction of the holder 108.

Also, as described below, when the connection portion 118 and the partner terminal 106 are fastened to each other by bolt, the partner terminal 106 inserted from above the holder 108 is accommodated in the partner terminal accommodation portion 110 surrounded by the first contact portions 150 and the second contact portions 152, and is overlaid and placed on the upper surface of the connection portion 118. In particular, in the second embodiment, when the connection portion 118 is placed on the holder 108, the upper surface of the connection portion 118 is located below the lower ends of the first inclined surfaces 154 and the second inclined surfaces 156. As a result, in the second embodiment, the partner terminal accommodation portion 110 is provided between the nut 24 and the lower ends of the first inclined surfaces 154 and the second inclined surfaces 156, in the height direction of the holder 108.

### Method for Assembling Terminal Connection Unit 100

Hereinafter, a specific example of a method for assembling the terminal connection unit 100 will be described. Note that the method for assembling the terminal connection unit 100 is not limited to the embodiment described below.

First, the upper main body 124 and the lower main body 50 are overlaid in the up-down direction and fixed to each other. This completes the support portion main body 122. Also, the nut 24 is accommodated in the nut accommodation portion 158 of the holder 108 and fixed as necessary, whereby the nut 24 is held by the holder 108. Thereafter, the locking plate 162 of the holder 108 holding the nut 24 is inserted into the locking plate insertion hole 130 of the support portion main body 122, and the contact portions 164 on both the left and right sides are brought into contact with the upper surface of the support portion main body 122. Thereafter, by displacing the entire holder 108 rearward, the locking plate 162 and the coupling portion 160 protruding downward from the holder 108 pass over the pass-over projection 134 provided on the upper base portion 126 and are located within the through hole 128 located rearward of the locking plate insertion hole 130. As a result, the holder 108 is attached to the support portion main body 122, and the support portion 102 is completed. After the holder 108 is attached to the support portion main body 122 in this manner, the coupling portion 160 and the pass-over projection 134 come into contact with each other, thereby preventing the holder 108 from coming out upward through the locking plate insertion hole 130.

Next, similarly to the first embodiment, the busbar 40 extending from the vehicle-mounted component such as a junction box and the electrically conductive member 101 are coupled to each other. By fixing the electrically conductive member 101 in this manner, the connection portion 118 of the electrically conductive member 101 is inserted and accommodated in the connection portion accommodation portion 166 in the holder 108 through the rearward draw-out opening 146 of the holder 108, and the connection portion 118 is overlaid and placed on the bottom wall 138. As a result, the bolt insertion hole 120 in the connection portion 118 and the inner hole 91 of the nut 24 are in communication with each other in the up-down direction, and in this state, the terminal connection unit 100 is completed.

### Method for Connecting Connection Portion 118 and Partner Terminal 106

Hereinafter, a specific example of a method for connecting the connection portion 118 of the electrically conductive member 101 to the partner terminal 106 in the terminal connection unit 100 assembled as described above will be described. Note that the method for connecting the connection portion 118 and the partner terminal 106 is not limited to the embodiment described below.

First, as shown in FIGS. 14 and 15, the front end of the partner-side busbar 104 is placed on the terminal block 34 of the partner-side device, the positioning pin 36 on the terminal block 34 is inserted into the positioning hole 116, and the partner terminal 106 (terminal portion 112) at the rear end of the partner-side busbar 104 is inserted from above the holder 108. In this state, as shown in FIG. 15, the connection portion 118 and the terminal portion 112 of the electrically conductive member 101 face each other in the up-down direction. However, due to the tolerance of the partner-side busbar 104 and the like, it is conceivable that the bolt insertion hole 30 in the terminal portion 112 and the inner hole 91 of the nut 24 held by the holder 108 are misaligned, as shown in the plan view of FIG. 14. In particular, in FIG. 14, the terminal portion 112 is shown biased to the left and rearward relative to the center of the holder 108, with the leftward end of terminal portion 112 in contact with the upper ends of the leftward second contact portions 152 (the second inclined surfaces 156) of the holder 108, and the rearward end of the terminal portion 112 in contact with the upper ends of the rearward first contact portions 150 (the first inclined surfaces 154).

By pushing the partner-side busbar 104 downward in this state, as shown in FIGS. 16 and 17, the holder 108 is displaced in a direction in which the bolt insertion hole 30 and the inner hole 91 of the nut 24 are positionally aligned as the terminal portion 112 comes into contact with the first contact portions 150 (the first inclined surfaces 154) and the second contact portions 152 (the second inclined surfaces 156). Specifically, the holder 108 moves rearward (in the first direction) on the support portion main body 122 as the rear end of the terminal portion 112 comes into contact with the rear first contact portions 150 (the first inclined surfaces 154). In addition, the holder 108 moves leftward (second direction) on the support portion main body 122 as the left end of terminal portion 112 comes into contact with the second contact portions 152 (second inclined surfaces 156) on the left.

Then, as shown in FIGS. 9 to 11, by pushing the partner-side busbar 104 all the way down, the terminal portion 112 comes into contact with the first contact portions 150 and is guided in the first direction (front-rear direction), and comes into contact with the second contact portions 152 and is guided in the second direction (left-right direction). As a result, the terminal portion 112 is accommodated in the partner terminal accommodation portion 110 surrounded by the first contact portions 150 (the first inclined surfaces 154) and the second contact portions 152 (the second inclined surfaces 156). As a result, the terminal portion 112 and the connection portion 118 are overlaid in the up-down direction in a state in which the terminal portion 112 and the inner hole 91 of the nut 24 provided on the holder 108 are positionally aligned with each other. Then, a bolt (not shown) is inserted through the bolt insertion hole 30 in the terminal portion 112 and the bolt insertion hole 120 in the connection portion 118, which are in communication with each other in the up-down direction, and the bolt is fastened to the nut 24, thereby completing the connection between the connection portion 118 and the partner terminal 106 (terminal portion 112). In this manner, in the second embodiment as well, the coupling member that couples the partner terminal 106 and the connection portion 118 includes the holder 108, and the support portion 102 has the coupling member (holder 108). Then, an external force accompanying the downward displacement of the partner terminal 106 is applied to the holder 108, whereby the holder 108 can be displaced in the left-right direction and the front-rear direction with respect to the support portion main body 122 of the support portion 102.

In the second embodiment, the coupling portion 160 protruding downward from the holder 108 is inserted into the through hole 128 of the support portion main body 122, and the coupling portion 160 is movable inside the through hole 128 in the first direction (front-rear direction) and the second direction (left-right direction). This allows the holder 108 to move on the support portion main body 122 in the front-rear direction and the left-right direction. Also, since the bolt insertion hole 120 in the connection portion 118 has a wide shape extending not only in the front-rear direction but also in the left-right direction, the bolt insertion hole 30 in the terminal portion 112, the bolt insertion hole 120 in the connection portion 118, and the inner hole 91 of the nut 24 are positionally aligned and are in communication with each other in the up down direction, regardless of whether the holder 108 moves in the front-rear direction or the left-right direction.

In the terminal connection unit 100 of the second embodiment having the above-described structure as well, when connecting the partner terminal 106 and the connection portion 118 of the electrically conductive member 101, the partner terminal 106 (terminal portion 112) can be brought into contact with the contact portion 148 (the first contact portions 150 and the second contact portions 152) in the holder 108, whereby the terminal portion 112 is guided into the partner terminal accommodation portion 110. As a result, the same effect as in the first embodiment is achieved.

In particular, due to the through hole 128 provided in the support portion main body 122 having a wide shape extending not only in the front-rear direction but also in the left-right direction, the holder 108 is capable of moving on the support portion main body 122 not only in the front-rear direction but also in the left-right direction. Similarly, due to the bolt insertion hole 120 provided in the connection portion 118 having a wide shape extending not only in the front-rear direction but also in the left-right direction, regardless of the direction in which the holder 108 moves, the bolt insertion hole 30 in the terminal portion 112 and the bolt insertion hole 120 in the connection portion 118 are in communication with each other in the up-down direction, and consequently are also in communication with the inner hole 91 of the nut 24.

Each first contact portion 150 has a first inclined surface 154, each second contact portion 152 has a second inclined surface 156, and the area surrounded by the first contact portions 150 (the first inclined surfaces 154) and the second contact portions 152 (the second inclined surfaces 156) is the partner terminal accommodation portion 110. As a result, by pushing the terminal portion 112 downward, the terminal portion 112 is automatically accommodated in the partner terminal accommodation portion 110 as the peripheral edge of the terminal portion 112 comes into contact with the first inclined surfaces 154 and/or the second inclined surfaces 156. As a result, even if the partner-side busbar 104 is an elongated busbar, the positional alignment of the bolt insertion holes 30 and 120 and the nut 24 is achieved simply by placing the front end of the partner-side busbar 104 on the terminal block 34 of the partner-side device and inserting the rear end from above the holder 108 and pushing it downward. Therefore, the task of connecting the partner terminal 106 and the connection portion 118 can be performed by one person, thereby improving the work efficiency.

The bent portion 114 is provided at the rear end portion of the partner-side busbar 104, and the terminal portion 112 is located lower than the front end side of the partner-side busbar 104. This makes it possible to reduce the amount of downward pushing of the partner-side busbar 104, and to reduce the risk of the partner-side busbar 104 interfering with members or the like located between the terminal connection unit 100 and the terminal block 34 of the partner-side device when the partner-side busbar 104 is pushed downward.

### Third Embodiment

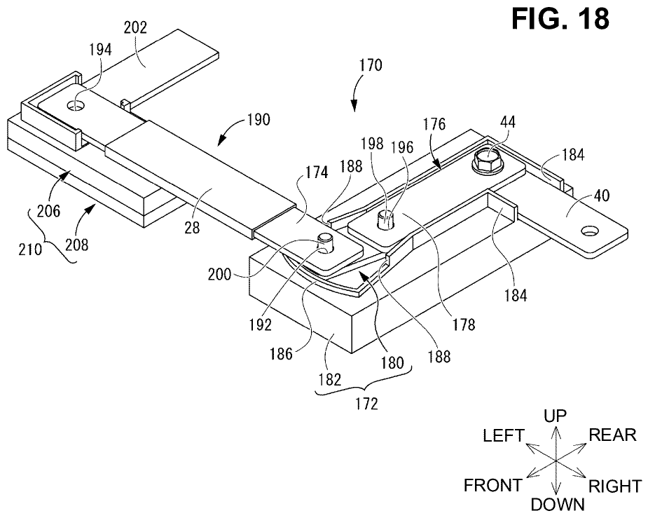

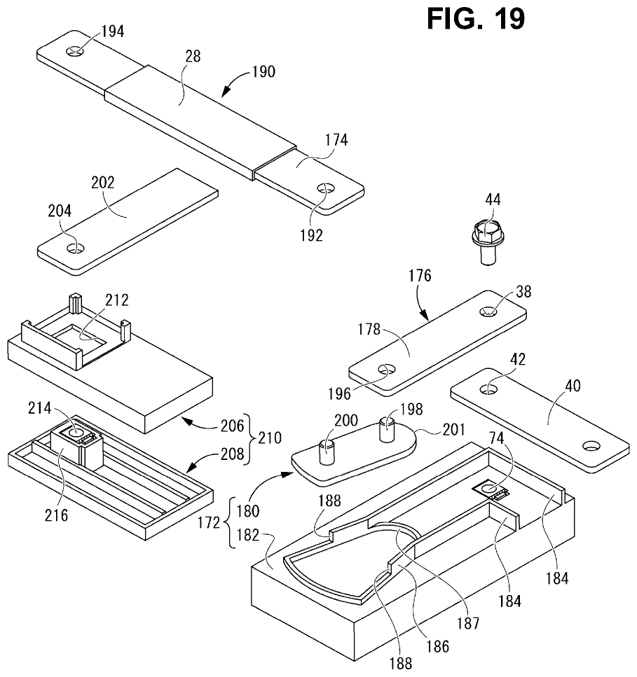

Next, a terminal connection unit 170 according to a third embodiment of the present disclosure will be described with reference to FIGS. 18 to 25. In the terminal connection unit 170 of the third embodiment as well, the basic configuration is similar to that of the first and second embodiments, and a support portion 172 has a coupling member that couples a partner terminal 174 and a connection portion 178 of an electrically conductive member 176 constituted by a busbar to each other. In the first and second embodiments, the coupling member is constituted by the holders 22 and 108, but in the third embodiment, the coupling member is constituted by a busbar 180. An external force accompanying displacement of the partner terminal 174 is exerted on the busbar 180, whereby the busbar 180 is capable of being displaced with respect to a support portion main body 182 of the support portion 172. Note that in the third embodiment, the up-down direction, the front-rear direction, and the left-right direction will be described as the directions shown in FIG. 18. In the third embodiment, members and parts that are substantially the same as those in the first embodiment are denoted in the drawings by the same reference numerals as those in the first embodiment, and detailed description thereof is omitted.

### Support Portion 172

The support portion 172 includes the busbar 180 and the support portion main body 182. The support portion main body 182 is a member having an approximately rectangular shape in a plan view, and is made of insulating synthetic resin or the like, for example. The support portion main body 182 extends in the front-rear direction, and a nut 74 is embedded in the rear end of the support portion main body 182. At the rear end portion of this support portion main body 182, similarly to the first embodiment, the rear end of the electrically conductive member 176 and the busbar 40 extending rightward are overlaid, and the bolt insertion holes 38 and 42 provided therein are positionally aligned. The bolt 44 is inserted into the bolt insertion holes 38 and 42 and fastened to the nut 74, whereby the electrically conductive member 176 and the busbar 40 are fixed to each other in an electrically continuous state. In short, the electrically conductive member 176 and the busbar 40 are supported in a fixed manner on the upper surface of the support portion main body 182, and a pair of side wall portions 184 protruding upward from the upper surface of the support portion main body 182 are provided on both side edges in the width direction of the electrically conductive member 176 and the busbar 40.

Also, a restricting wall portion 186 that restricts rotational displacement of the busbar 180 by coming into contact with both side surfaces of the busbar 180 serving as the coupling member when the busbar 180 undergoes rotational displacement about a later-described first pin 198 is provided on the upper surface of the support portion main body 182. The restricting wall portion 186 has an annular frame shape overall, and is approximately fan-shaped with a predetermined central angle centered on the position where the first pin 198 is formed in a plan view. As a result, the outer shape of the restricting wall portion 186 is such that the circumferential dimension of the outer circumferential portion (frontward portion) is larger than the circumferential dimension of the inner circumferential portion (rearward portion). The rearward portion of the inner surface of the restricting wall portion 186 is a curved surface 187 having a predetermined dimension in the peripheral direction. In the first embodiment, the restricting wall portion 186 is formed integrally with the pair of side wall portions 184 described above. In particular, in the first embodiment, notch-shaped openings 188 are provided on both the left and right sides of the frontward portion of the restricting wall portion 186, and by providing these openings 188, the dimension in the up-down direction of the frontward portion of the restricting wall portion 186 is made smaller than that of the rearward portion. Also, the partner terminal 174 to be coupled to a later-described second pin 200 of the busbar 180 extends to the outside of the support portion 172 through the openings 188 in the restricting wall portion 186.

### Partner Terminal 174 (Partner-Side Busbar 190)

The partner terminal 174 is formed at one end of a partner-side busbar 190. In the third embodiment, the partner-side busbar 190 extends in a direction (left-right direction) approximately perpendicular to the support portion 172, and the partner terminal 174 is formed at the right end of the partner-side busbar 190. The partner terminal 174 has a circular pin insertion hole 192 through which the later-described second pin 200 is to be inserted, the pin insertion hole 192 passing through the partner terminal 174 in the thickness direction (up-down direction). At the other end of the partner-side busbar 190 as well, a metal flat plate constituting the partner-side busbar 190 is exposed without being provided with an insulating coating 28, and a bolt insertion hole 194 passing through in the thickness direction (up-down direction) is formed in the metal flat plate exposed at the other end of the partner-side busbar 190. Note that, similarly to the first embodiment, the partner-side busbar 190 is preferably an elongated thick busbar having a relatively large cross-sectional area, high deformation rigidity, and relatively large tolerance. This allows the effects of the present disclosure to be effectively achieved.

### Electrically Conductive Member 176

The electrically conductive member 176 is constituted by a busbar extending in the front-rear direction, similarly to the first embodiment, and the front end of the busbar is the connection portion 178. A circular pin insertion hole 196, through which the later-described first pin 198 is to be inserted, is formed in the connection portion 178 so as to pass through the connection portion 178 in the thickness direction (up-down direction). As described above, the bolt insertion hole 38 is formed in the rear end of the electrically conductive member 176.

### Coupling Member (Busbar 180)

The busbar 180 serving as a coupling member has an approximately rectangular flat plate shape, and is a metal flat plate made of copper (including copper alloy) or aluminum (including aluminum alloy) having excellent electrical conductivity. The busbar 180 extends in the front-rear direction overall, a first pin 198 that protrudes upward is provided at the rear end, which is one end in the length direction of the busbar 180, and a second pin 200 that protrudes upward is provided at the front end, which is another end in the length direction of the busbar 180. In the third embodiment, the first and second pins 198 and 200 are formed integrally with the busbar 180, but they may also be formed separately from the busbar 180. Also, the rearward end surface of the busbar 180 is a curved surface 201, and when the busbar 180 is subjected to rotational displacement about the central axis of the first pin 198 as described below, interference between the rearward portion of the inner surface of restricting wall portion 186 and the rear end face of the busbar 180 is avoided, thereby realizing smooth displacement of the busbar 180.

Here, when assembling the terminal connection unit 170, the rear end of the busbar 180 is coupled to the connection portion 178 by inserting the first pin 198 into the pin insertion hole 196 in the connection portion 178, whereby the busbar 180 is capable of rotational displacement about the central axis of the first pin 198 with respect to the connection portion 178. Similarly, the front end of the busbar 180 is coupled to the partner terminal 174 by inserting the second pin 200 into the pin insertion hole 192 in the partner terminal 174, whereby the busbar 180 is capable of rotational displacement about the central axis of the second pin 200 with respect to the partner terminal 174. In this manner, the connection portion 178 and the partner terminal 174 are coupled via the busbar 180, whereby the electrically conductive member 176 and the partner-side busbar 190 are electrically connected to each other.

### Third Busbar 202

A third busbar 202 is coupled to the other end of the partner-side busbar 190. The third busbar 202 extends in a direction (front-rear direction) approximately perpendicular to the length direction of the partner-side busbar 190, and a circular bolt insertion hole 204 is formed in the front end of the third busbar 202. A terminal block 210 constituted by an upper base portion 206 and a lower base portion 208 is provided below the third busbar 202. A through window 212 passing through in the thickness direction (up-down direction) is formed in the upper base portion 206, and an upward protruding portion 216 including a nut 214 at its upper end is formed in the lower base portion 208. As a result, when the upper base portion 206 and the lower base portion 208 are fixed together by, for example, press-fitting to form the terminal block 210, the upward protruding portion 216 is inserted into the through window 212 and the nut 214 is exposed upward. Note that it is preferable that the third busbar 202 is provided on the terminal block 210 in a fixed manner, or positional misalignment therebetween is substantially prevented by a mechanism not shown in the drawings, and it is preferable that the bolt insertion hole 204 in the third busbar 202 and the nut 214 in the terminal block 210 are held in communication with each other in the up-down direction.

### Method for Assembling Terminal Connection Unit 170

Hereinafter, a specific example of a method for assembling the terminal connection unit 170 will be described. Note that the method for assembling the terminal connection unit 170 is not limited to the embodiment described below.

First, the busbar 180 is placed inside the frame-shaped restricting wall portion 186 of the support portion main body 182. Also, the busbar 40 is placed on the rear end of the support portion main body 182, and the electrically conductive member 176 is overlaid on the busbar 40. As a result, the first pin 198 of the busbar 180 is inserted into the pin insertion hole 196 in the connection portion 178 of the electrically conductive member 176, and the nut 74 in the support portion main body 182, the bolt insertion hole 42 in the busbar 40, and the bolt insertion hole 38 in the electrically conductive member 176 are positionally aligned with each other. Then, the bolt 44 is inserted through both of the bolt insertion holes 38 and 42 and fastened to the nut 74. As a result, the electrically conductive member 176 is supported in a fixed manner on support portion main body 182, and the busbar 180 is capable of rotational displacement about the central axis of the first pin 198 with respect to the connection portion 178. The partner-side busbar 190 is overlaid on this busbar 180 from above, and the second pin 200 of the busbar 180 is inserted into the pin insertion hole 192 of the partner terminal 174. In this way, the terminal connection unit 170 of the third embodiment is formed. In this terminal connection unit 170, the partner-side busbar 190 can be subjected to rotational displacement about the central axis of the second pin 200 with respect to the busbar 180.

### Method for Connecting Partner-Side Busbar 190 and Third Busbar 202

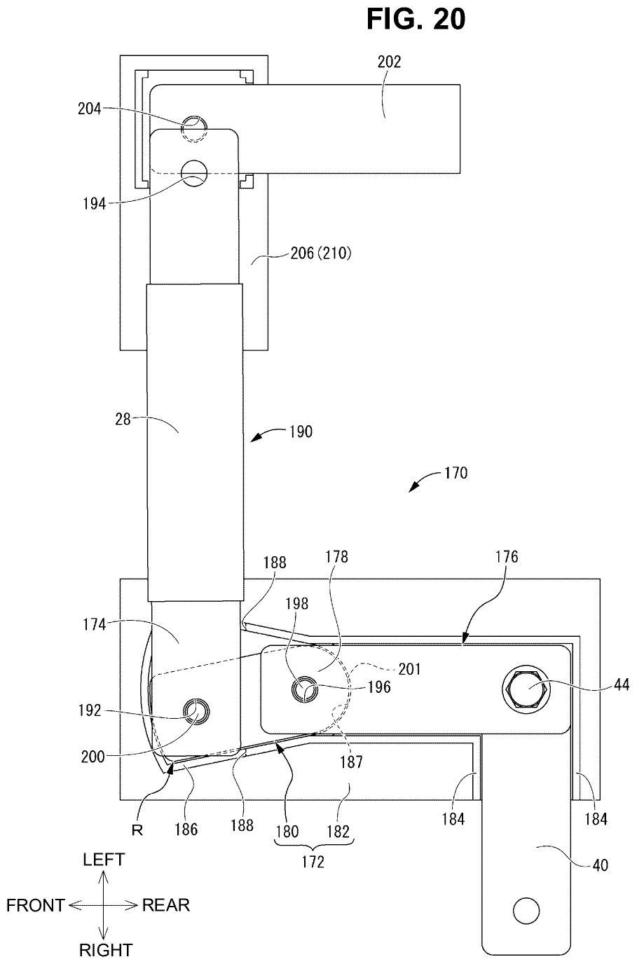

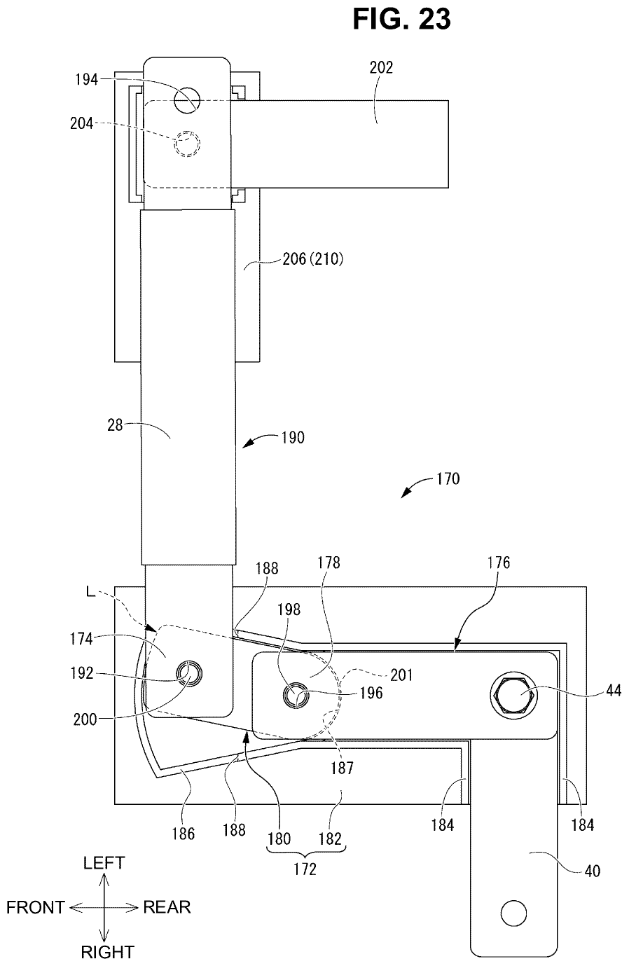

Hereinafter, a specific example of a method for connecting the partner-side busbar 190 and the third busbar 202 using the terminal connection unit 170 assembled as described above will be described. The method for connecting the partner-side busbar 190 and the third busbar 202 is not limited to the mode described below. FIGS. 20 to 22 show a case where the length dimension of the partner-side busbar 190 is shorter than a reference dimension by a tolerance, and FIGS. 23 to 25 show a case where the length dimension of the partner-side busbar 190 is longer than the reference dimension by a tolerance. Note that the third busbar 202 is supported in a fixed manner on the terminal block 210, and the bolt insertion hole 204 in the third busbar 202 and the inner hole of the nut 214 on the terminal block 210 are in communication with each other.

As shown in FIG. 20, if the partner-side busbar 190 is shorter than the reference dimension, simply inserting the second pin 200 into the pin insertion hole 192 of the partner terminal 174 to couple the busbar 180 and the partner-side busbar 190 may not result in the bolt insertion hole 194 provided at the other end of the partner-side busbar 190 reaching the bolt insertion hole 204 in the third busbar 202. Specifically, for example, if the other end (front end) in the length direction of the busbar 180 is located on the right side (right position R) within the restricting wall portion 186 as shown in FIG. 20, there is a relatively large misalignment between bolt insertion hole 194 in the partner-side busbar 190 and the bolt insertion hole 204 in the third busbar 202.

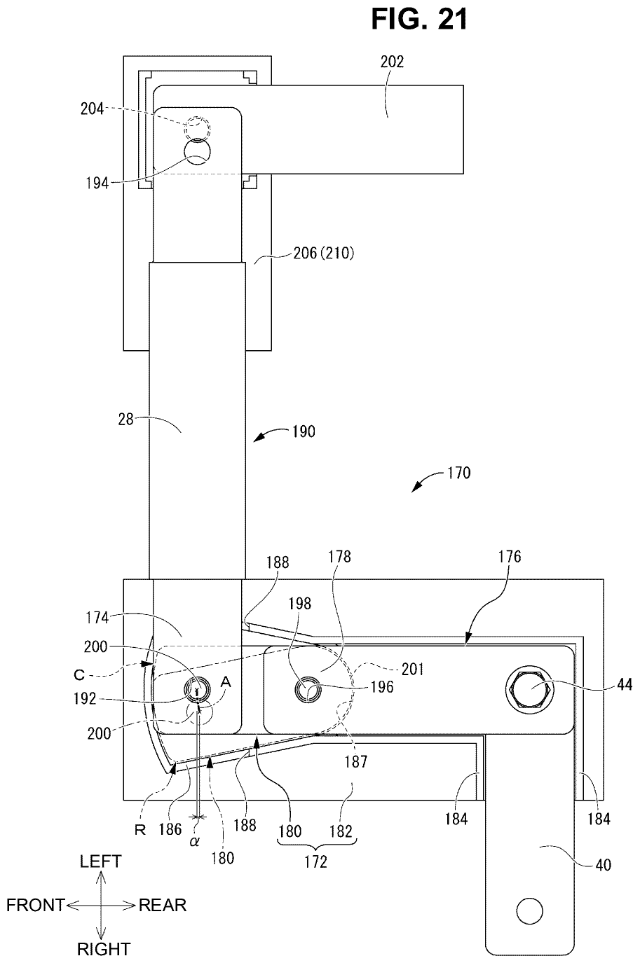

In view of this, when the second pin 200 is inserted through the pin insertion hole 192 and the busbar 180 and the partner-side busbar 190 are coupled to each other, the partner-side busbar 190 is displaced leftward. An external force accompanying this displacement of the partner-side busbar 190 is exerted on the busbar 180 via the second pin 200, whereby the partner terminal 174 is subjected to rotational displacement about the central axis of the second pin 200 with respect to the busbar 180, and the busbar 180 is subjected to rotational displacement about the central axis of the first pin 198 with respect to the connection portion 178. As a result, the busbar 180 is subjected to rotational displacement about the central axis of the first pin 198 with respect to the support portion main body 182, and the front end portion of the busbar 180 is located at the center (central position C) within the restricting wall portion 186 as shown in FIG. 21. In this state, the misalignment between the bolt insertion hole 194 in the partner-side busbar 190 and the bolt insertion hole 204 in the third busbar 202 is smaller than in FIG. 20, but there is still some misalignment between the two bolt insertion holes 194 and 204.

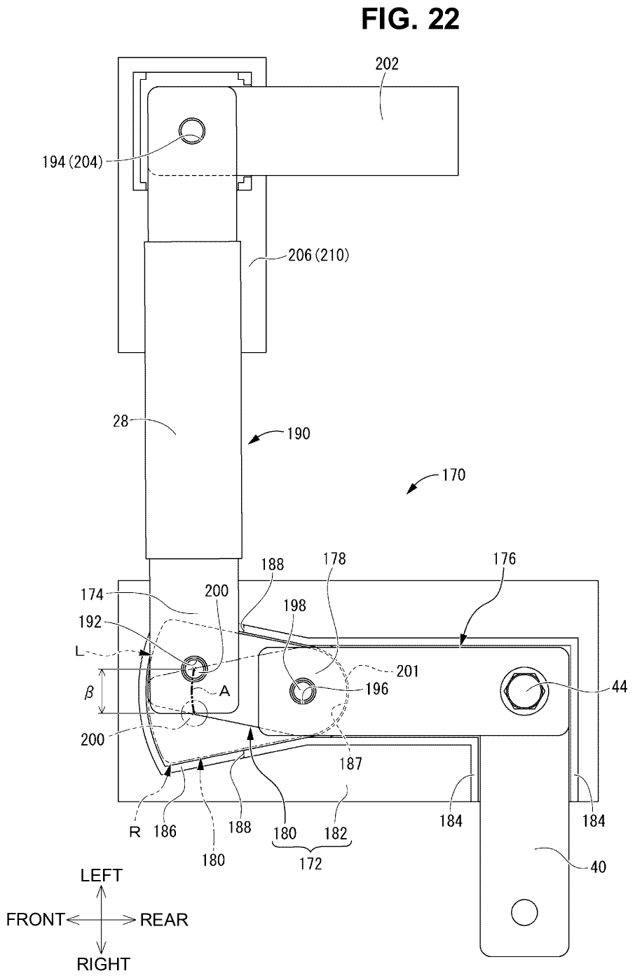

Therefore, the partner-side busbar 190 is displaced further leftward. As a result, the busbar 180 is further subjected to rotational displacement about the central axis of the first pin 198 with respect to the support portion main body 182, and the front end of the busbar 180 is located on the left side (left position L) within the restricting wall portion 186, as shown in FIG. 22. As a result, the misalignment between the bolt insertion hole 194 in the partner-side busbar 190 and the bolt insertion hole 204 in the third busbar 202 is smaller than in FIG. 21, and both of the bolt insertion holes 194 and 204 are positionally aligned and in communication with each other. Then, a bolt (not shown) is inserted into these bolt insertion holes 194 and 204 and fastened to the nut 214, whereby the partner-side busbar 190 and the third busbar 202 are coupled and electrically connected to each other. As a result, an electrical path is formed from the busbar 40 to the third busbar 202, through the electrically conductive member 176, the busbar 180, and the partner-side busbar 190.

Similarly, as shown in FIG. 23, if the partner-side busbar 190 is longer than the reference dimension, simply coupling the busbar 180 and the partner-side busbar 190 may result in a relatively large misalignment between the bolt insertion hole 194 at the other end of the partner-side busbar 190 and the bolt insertion hole 204 in the third busbar 202. Specifically, for example, as shown in FIG. 23, the front end of the busbar 180 is located on the left side (left position L) within the restricting wall portion 186 in some cases.

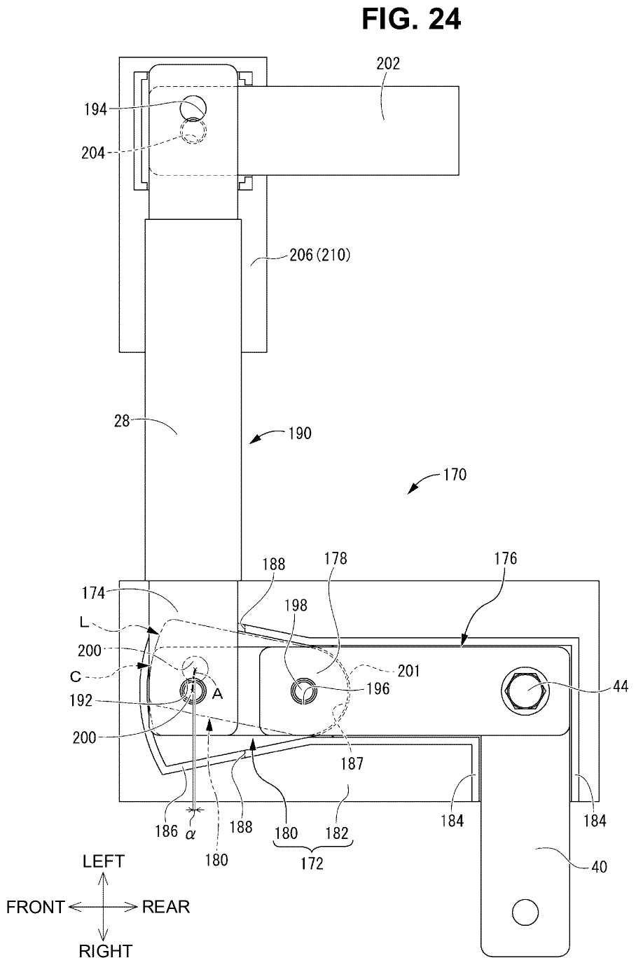

In such a case, when the busbar 180 and the partner-side busbar 190 are coupled to each other, the partner-side busbar 190 is displaced to the right. An external force accompanying the displacement of the partner-side busbar 190 is exerted on the busbar 180 via the second pin 200, whereby the busbar 180 is subjected to rotational displacement about the central axis of the first pin 198 with respect to the support portion main body 182, and the front end of the busbar 180 is located in the center (central position C) within the restricting wall portion 186, as shown in FIG. 24. In this state, the misalignment between the bolt insertion hole 194 in the partner-side busbar 190 and the bolt insertion hole 204 in the third busbar 202 is smaller than in FIG. 23, but there is still some misalignment between the two bolt insertion holes 194 and 204.

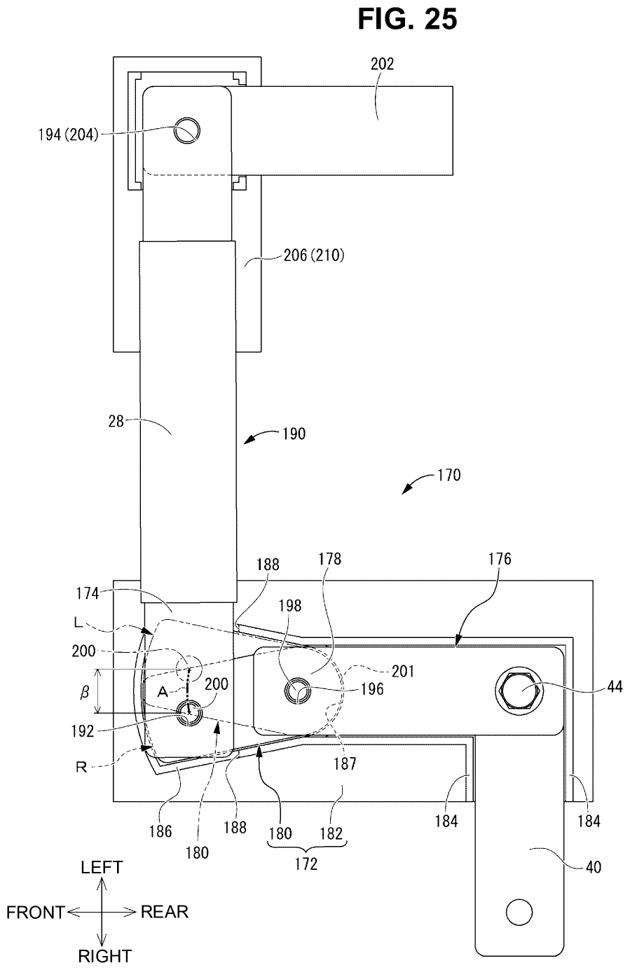

In view of this, the partner-side busbar 190 is displaced further rightward. As a result, the busbar 180 is further subjected to rotational displacement about the central axis of the first pin 198 with respect to the support portion main body 182, and the front end of the busbar 180 is located on the right side (right position R) within the restricting wall portion 186, as shown in FIG. 25. As a result, the misalignment between the bolt insertion hole 194 in the partner-side busbar 190 and the bolt insertion hole 204 in the third busbar 202 is smaller than in FIG. 24, and both of the bolt insertion holes 194 and 204 are positionally aligned and in communication with each other. Then, a bolt (not shown) is inserted into these bolt insertion holes 194 and 204 and fastened to the nut 214, whereby the partner-side busbar 190 and the third busbar 202 are coupled and electrically connected to each other. As a result, an electrical path is formed from the busbar 40 to the third busbar 202, through the electrically conductive member 176, the busbar 180, and the partner-side busbar 190.

That is, by using the terminal connection unit 170 of the third embodiment, the distance between the second pin 200 in the busbar 180 and the bolt insertion hole 204 in the third busbar 202 can be adjusted according to the length dimension of the partner-side busbar 190. As a result, the tolerance of the partner-side busbar 190, which is a thick busbar and tends to have a large tolerance, can be absorbed. That is, in the third embodiment as well, by displacing the partner-side busbar 190 while the second pin 200 is inserted into the pin insertion hole 192 to couple the partner-side busbar 190 and the busbar 180 to each other, an external force accompanying this displacement of the partner-side busbar 190 is exerted on the busbar 180. The busbar 180, which is the coupling member, is displaced with respect to the support portion main body 182, thereby achieving the same effect as in the first embodiment.

In particular, in the third embodiment, the busbar 180 is subjected to rotational displacement about the central axis of the first pin 198 with respect to the support portion main body 182. As a result, the front end of the busbar 180, that is, the central axis of second pin 200, moves in an arc shape in a plan view. In FIGS. 21 and 22, the arc-shaped paths A of the central axis of the second pin 200 from the right position R to the center position C and the left position L are indicated by two-dot chain lines. In FIGS. 24 and 25, the arc-shaped paths A of the central axis of the second pin 200 from the left position L to the center position C and the right position R are indicated by two-dot chain lines. As shown in FIGS. 21 and 24, the second pin 200 can move not only in the left-right direction but also in the front-rear direction by a movement distance α, thereby allowing the partner terminal 174 connected to the second pin 200 to also move in the front-rear direction by the movement distance α. Also, the front end (second pin 200) of the busbar 180 can move in the left-right direction by a movement distance β, as shown in FIGS. 22 and 25, thereby allowing the partner terminal 174 to also move in the left-right direction by the movement distance β. As a result, the terminal connection unit 170 of the third embodiment can absorb tolerances in two directions that are perpendicular to each other (front-rear direction and left-right direction).

Furthermore, by adopting such a tolerance absorption structure, it is sufficient that the circular pin insertion holes 196 and 192 are provided in the connection portion 178 and the partner terminal 174, and therefore no bolt insertion holes 20 and 120 with elongated shapes as in the first and second embodiments are provided, and it is possible to ensure a greater amount of metal forming the electrically conductive member 176 and the partner-side busbar 190. As a result, the electrical conductivity and rigidity are improved.

Also, due to the partner-side busbar 190 being connected to the connection portion 178 via two pins (first and second pins 198 and 200), the other end (bolt insertion hole 194) of the partner-side busbar 190 can be displaced over a larger region with respect to the connection portion 178. This enables the bolt insertion holes 194 in the partner-side busbar 190 and the bolt insertion holes 204 in the third busbar 202 to be more reliably positionally aligned, whereby the bolt fastening between the partner-side busbar 190 and the third busbar 202 can be achieved more reliably.

### Modified Examples

Although the first to third embodiments have been described above as specific examples of the present disclosure, the present disclosure is not limited to these specific descriptions. Modifications, improvements, and the like within the scope that achieves the object of this disclosure are encompassed in this disclosure. For example, the following modifications of the embodiments are also encompassed within the technical scope of the present disclosure.

(1) In the above-described first and second embodiments, the holders 22 and 108 hold the nut 24, and a bolt (not shown) is inserted from above into the partner terminals 14 and 106 and the connection portions 16 and 118 to fix the partner terminals 14 and 106 and the connection portions 16 and 118 to each other, but there is no limitation to this mode. That is, the holder may hold a bolt that protrudes upward, in which case the partner terminal is provided with, for example, a bolt insertion groove extending frontward from the rear end of the partner terminal, instead of a circular bolt insertion hole. Then, the connection portion is overlaid on the holder from above, whereby the bolt protruding upward is inserted into the bolt insertion hole with the elongated shape, and the partner terminal is overlaid on the upper surface of the connection portion from the front, whereby the bolt is inserted into the bolt insertion groove from the rear. Thereafter, the rear end of the partner terminal is brought into contact with the contact portion on the holder to displace the holder to an appropriate position, and the connection portion and the partner terminal can be fixed to each other by tightening a nut onto the bolt protruding upward.

(2) In the above-described first embodiment, the front surface of each engaging projection 56 is an inclined surface 58 and the rear surface is a vertical surface 60, whereby the holder 22 can be displaced in one direction from the front to the rear. However, both the front and rear surfaces of each engaging projection may be inclined surfaces, whereby the holder can be displaced in both directions in the front-rear direction. In this case, movement from front to rear in the holder is achieved by bringing the rear end of the partner terminal into contact with the contact portion in the holder as in the first embodiment, and movement from rear to front in the holder may be achieved manually, for example, by an operator pressing the contact portion that protrudes upward with his or her finger.

(3) In the third embodiment, the first and second pins 198 and 200 protruding upward from the busbar 180 are integrally formed with the busbar 180, and the connection portion 178 and the partner terminal 174 are overlaid on the busbar 180 from above, but there is no limitation to this mode. That is, for example, the first and second pins may be provided so as to protrude upward from the support portion main body, and pin insertion holes through which the first and second pins are inserted may be provided at both ends in the length direction of the coupling member. Alternatively, the first and second pins may protrude downward from the connection portion or the partner terminal, and pin insertion holes through which the first and second pins are inserted may be provided at both ends in the length direction of the coupling member. Alternatively, the coupling member may be provided with first and second pins that protrude downward, and the coupling member may be overlaid from above the connection portion and the partner terminal, whereby the first and second pins are inserted into pin insertion holes provided in the connection portion and the partner terminal. In short, in the third embodiment, it is sufficient that the connection portion and the coupling member, and the coupling member and the partner terminal are respectively coupled by pins, and the member in which the pin and the pin insertion hole through which the pin is inserted are provided is not limited.

(4) In the third embodiment, the third busbar 202 is located leftward of the electrically conductive member 176, and the partner-side busbar 190 extends in an approximately perpendicular direction from the electrically conductive member 176 via the busbar 180. However, there is no limitation to this mode. That is, for example, the third busbar may be located frontward of the electrically conductive member, and the partner-side busbar may extend in substantially the same direction as the electrically conductive member via the coupling member. Note that the member coupled to the other end of the partner-side busbar is not limited to a busbar (third busbar 202 in the embodiment) and may be a terminal provided at the end of an electric wire, for example.

(5) The shape of the partner-side busbar is not limited, but it is preferable that the partner-side busbar is long and thick as described in the above embodiment. That is, since the partner-side busbar is long and thick, which tends to result in large tolerances, the terminal connection unit according to the present disclosure can effectively absorb the tolerances.

### LIST OF REFERENCE NUMERALS

10 Terminal connection unit (first embodiment)
12 Electrically conductive member (busbar)
14 Partner terminal
16 Connection portion
18 Support portion
20 Bolt insertion hole
22 Holder (coupling member)
24 Nut
26 Partner-side busbar
28 Insulating covering
30 Bolt insertion hole
32 Positioning hole
34 Terminal block
36 Positioning pin
38 Bolt insertion hole
40 Busbar
42 Bolt insertion hole
44 Bolt
46 Support portion main body
48 Upper main body
50 Lower main body
52 Upper base portion
54 Guide rail
55a Frontward opening
55b Rearward opening
55c Upward opening
56 Engaging projection
58 Inclined surface
60 Vertical surface
62 Through window
64 Frame-shaped portion
66 Rightward draw-out opening
68 Frontward draw-out opening
70 Lower base portion
72 Upward protruding portion
74 Nut
76 Bottom wall
78 Peripheral wall
80 Rear wall
82 Side wall
84 Rearward draw-out opening
86 Contact portion
88 Claw portion
89 Inclined surface
90 Nut accommodation portion
91 Inner hole
92 Connection portion accommodation portion
94 Partner terminal accommodation portion
100 Terminal connection unit (second embodiment)
101 Electrically conductive member
102 Support portion
104 Partner-side busbar (busbar)
106 Partner terminal
108 Holder (coupling member)
110 Partner terminal accommodation portion
112 Terminal portion
114 Bent portion
116 Positioning hole
118 Connection portion
120 Bolt insertion hole
122 Support portion main body
124 Upper main body
126 Upper base portion
128 Through hole
130 Locking plate insertion hole
132 Elastic piece
134 Pass-over projection
136 Displacement restriction portion
138 Bottom wall
140 Peripheral wall
141 Front wall
142 Rear wall
144 Side wall
145 Frontward draw-out opening
146 Rearward draw-out opening
148 Contact portion
150 First contact portion
152 Second contact portion
154 First inclined surface
156 Second inclined surface
158 Nut accommodation portion
160 Coupling portion
162 Locking plate
164 Contact portion
166 Connection portion accommodation portion
170 Terminal connection unit (third embodiment)
172 Support portion
174 Partner terminal
176 Electrically conductive member (busbar)
178 Connection portion
180 Busbar (coupling member)
182 Support portion main body
184 Side wall portion
186 Restricting wall portion
187 Curved surface
188 Opening
190 Partner-side busbar
192 Pin insertion hole
194 Bolt insertion hole
196 Pin insertion hole
198 First pin
200 Second pin
201 Curved surface
202 Third busbar
204 Bolt insertion hole
206 Upper base portion
208 Lower base portion
210 Terminal block
212 Through window
214 Nut
216 Upward protruding portion
R Rightward portion
C Central portion
L Leftward position
A Path

1. A terminal connection unit comprising:
an electrically conductive member having a connection portion to which a partner terminal is to be connected; and
a support portion configured to support the electrically conductive member in a fixed manner,
wherein the support portion includes a coupling member configured to couple the partner terminal and the connection portion of the electrically conductive member to each other, and
the coupling member is displaceable with respect to a support portion main body of the support portion due to an external force accompanying displacement of the partner terminal being exerted on the coupling member.

2. The terminal connection unit according to claim 1,
wherein the connection portion of the electrically conductive member has an elongated bolt insertion hole extending in a first direction,
the coupling member is constituted by a holder that is disposed below the connection portion and is attached to the support portion so as to be displaceable in the first direction,
the holder holds a nut or a bolt,
the holder includes a connection portion accommodation portion that is disposed above the nut or the bolt and is configured to accommodate the connection portion so as to be fastenable to the nut or the bolt, a partner terminal accommodation portion configured to accommodate the partner terminal, and a contact portion configured to come into contact with the partner terminal, and
due to the partner terminal coming into contact with the contact portion, the partner terminal is guided into the partner terminal accommodation portion so as to be fastenable to the nut or the bolt, and the holder is displaced in the first direction.

3. The terminal connection unit according to claim 2,
wherein the electrically conductive member is constituted by a busbar, the connection portion is provided at one end of the busbar, and the bolt through hole extends in a longitudinal direction of the busbar.

4. The terminal connection unit according to claim 2,
wherein the support portion includes a pair of guide rails that extend in the first direction and are arranged in parallel with a gap therebetween,
the connection portion of the electrically conductive member is inserted from one end of the guide rails and disposed therein, and
the holder engages with the guide rails so as to be displaceable in the first direction.

5. The terminal connection unit according to claim 4,
wherein the nut or the bolt held by the holder is disposed below the connection portion of the electrically conductive member, and the contact portion and the partner terminal accommodation portion of the holder are arranged above the connection portion of the electrically conductive member.

6. The terminal connection unit according to claim 4,
wherein in each of the pair of guide rails, a plurality of engaging projections that extend toward the other of the pair of guide rails and are capable of elastic deformation are arranged spaced apart from each other in the first direction, and
the holder has a pair of claw portions configured to engage with the engaging projections of the guide rails.

7. The terminal connection unit according to claim 2,
wherein the connection portion of the electrically conductive member has a wide bolt insertion hole that extends also in a second direction perpendicular to the first direction,
the holder is attached to the support portion so as to be displaceable also in the second direction,
the contact portion includes a first contact portion and a second contact portion,
due to the partner terminal coming into contact with the first contact portion, the partner terminal is guided into the partner terminal accommodation portion in the first direction and the holder is displaced in the first direction, and
due to the partner terminal coming into contact with the second contact portion, the partner terminal is guided into the partner terminal accommodation portion in the second direction and the holder is displaced in the second direction.

8. The terminal connection unit according to claim 7,
wherein the holder includes a bottom wall configured to hold the nut or the bolt in the center of the bottom wall,
a pair of first inclined surfaces that protrude upward as they extend outward in the first direction from side edges of the bottom wall that oppose each other in the first direction, and
a pair of second inclined surfaces that protrude upward as they extend outward in the second direction from side edges of the bottom wall that oppose each other in the second direction, and
in a height direction of the holder, the partner terminal accommodation portion and the connection portion accommodation portion are disposed between the nut or the bolt and lower ends of the first inclined surfaces and the second inclined surfaces.

9. The terminal connection unit according to claim 7, further comprising
the partner terminal included at one end of a partner-side busbar,
wherein the partner terminal includes a terminal portion having a size capable of being accommodated in the partner terminal accommodation portion, and a crank-shaped bent portion provided on another end of the partner-side busbar relative to the terminal portion, and
the terminal portion is disposed below the other end of the partner-side busbar.

10. The terminal connection unit according to claim 1,
wherein the coupling member is constituted by a busbar,
the connection portion and one end in a length direction of the coupling portion are coupled to each other by a first pin, whereby the coupling member is capable of rotational displacement about a central axis of the first pin with respect to the connection portion,
the partner terminal and another end in the length direction of the coupling member are coupled to each other by a second pin, whereby the coupling member is capable of rotational displacement about a central axis of the second pin with respect to the partner terminal, and
due to an external force accompanying displacement of the partner terminal being exerted on the coupling member, the coupling member coupled to the partner terminal by the second pin is capable of rotational displacement about the central axis of the first pin with respect to the support portion main body.

11. The terminal connection unit according to claim 10, further comprising
a partner-side busbar in which the partner terminal is formed at one end of the partner-side busbar, another end of the partner-side busbar being coupled to a third busbar,
wherein displacement of the partner-side busbar is allowed due to rotational displacement of the coupling member, a bolt through hole in the other end of the partner-side busbar and a bolt through hole in the third busbar are positionally aligned with each other, and the partner-side busbar and the third busbar are fixed to each other by bolt.
